(19) United States
(12) Patent Application Publication
(10) Pub. No.: US 2021/0289804 A1
(43) Pub. Date: Sep. 23, 2021

(54) NON-DAIRY ANALOGS WITH SUCCINYLATED PLANT PROTEINS AND METHODS USING SUCH PRODUCTS

(71) Applicant: RIPPLE FOODS, PBC, Berkeley, CA (US)

(72) Inventors: Amanda STILES, Richmond, CA (US); Celia HOMYAK, Oakland, CA (US); Savina ASTOR, Berkeley, CA (US); Bridget SMITH, Berkeley, CA (US)

(73) Assignee: RIPPLE FOODS, PBC, Berkeley, CA (US)

(21) Appl. No.: 17/339,180

(22) Filed: Jun. 4, 2021

Related U.S. Application Data
(63) Continuation of application No. PCT/US2019/064455, filed on Dec. 4, 2019.
(60) Provisional application No. 62/775,612, filed on Dec. 5, 2018.
(60) Provisional application No. 62/799,494, filed on Jan. 31, 2019.

(51) Int. Cl. A23C 11/10; A23J 3/14; A23D 7/00; A23L 2/38; A23L 29/10; A23L 33/15; A23L 2/60

(52) U.S. Cl. CPC A23C 11/10; A23J 3/14; A23D 7/003; A23L 2/60; A23L 29/10; A23L 33/15; A23L 2/38

(57) ABSTRACT

The present disclosure is related to non-dairy analogs and method of using such products. Certain embodiments are directed to non-dairy analogs where at least a portion of the protein used in the non-dairy analog is a succinylated refined protein. In certain embodiments, these non-dairy analogs improve the stability of the non-dairy analog when used as a substitute for a dairy product in food products including but not limited to yogurt, sour cream, ice cream, coffee creamer, heavy cream, whipping cream, pudding, soft cheese, or hard cheese. In certain embodiments, these non-dairy analogs reduce, substantially reduce or eliminate feathering when the non-dairy analog is added to acidic and/or hot beverages, for example, coffee or tea.

### CROSS-REFERENCE TO RELATED APPLICATIONS

This application is a continuation of PCT/2019/064455, filed Dec. 4, 2019, which claims priority benefit of U.S. Provisional Patent Applications 62/799,494, filed Jan. 31, 2019, and 62/775,612, filed Dec. 5, 2018, each of which is hereby incorporated herein by reference.

### FIELD

The present disclosure relates to food products that are derived substantially from or wholly from non-animal sources, for example, non-dairy analogs and method of using such products. Certain embodiments are directed to non-dairy analogs where at least a portion of the protein used in the non-dairy analog is a succinylated refined protein that which results in improved stability and solubility of the non-dairy analog, for example reducing feathering when added to beverages such as coffee or tea. These non-dairy analogs may also be used as a substitute for dairy products in a wide range of food products, including for example, yogurt, sour cream, creamers, and cheeses.

### BACKGROUND

Consumers often add dairy products such as creamers to beverages such as coffee or tea. Dairy creamers are often made with dairy milk and/or dairy cream. Dairy creamers are desired by many consumers because of the milky flavor and creamy texture they add to the beverage. In addition, these dairy creamers tend to mix well with the beverage. Dairy creamers, and other dairy-based products, however have many qualities that consumers find disadvantageous, including but not limited to, the presence of saturated fat, the amount of fat, the presence of cholesterol, and/or the presence of lactose. For example, many people would prefer a non-dairy alternative to dairy creamers because of the high fat and calorie levels. In addition, many people are not able tolerate such products due to lactose intolerance and/or prefer not to consume animal-based products.

There are known non-dairy analogs, for example some non-dairy analogs are made with sodium caseinate or whey proteins. Other known non-dairy analogs are made with a soy protein. However, these alternative non-dairy analogs suffer from several drawbacks, such as a thin and chalky mouth feel, a green or beany flavor, undesirable color and so forth. In particular, one set of problems with existing non-dairy analogs is relative lack of stability and/or solubility when added to a beverage such as coffee. When adding dairy milk or dairy creamer to coffee it typically dissolves well, remains stable within the solution, and provides a whitening or creamy look. A problem with existing non-dairy analogs is that they exhibit feathering when added to a beverage such as coffee or tea. Feathering is typically described as the presence of particles due to coagulation or precipitation of proteins within the beverage. Feathering imparts an undesirable visual experience and/or an undesirable mouthfeel experience for the consumer of the beverage in which it occurs. Proteins are typically a substantial component of non-dairy analogs and/or non-dairy milk products and their lack of stability, and/or lack of solubility are believed to play a role in feathering in these beverages.

To reduce feathering in non-dairy analogs it has been proposed to include inorganic salts in such products. For example, it has been proposed to include di-potassium hydrogen phosphate, sodium aluminum phosphate, and polyphosphates. However, the use of such inorganic salts has a negative impact on the taste, health and/or nutritional aspects of such non-dairy analogs. Therefore, there exists an unmet need for non-dairy milk and/or non-dairy analogs for use in food beverages such as coffee or tea that are stable, soluble, and/or do not feather or have a substantial reduction in feathering. The present disclosure provides such and related food products, methods of making such products and methods of using such products. The present disclosure is directed to solving these and other problems disclosed herein. The present disclosure is also directed to overcome and/or ameliorate at least one of the disadvantages of the prior art as will become apparent from the discussion herein. The present disclosure is also directed to addressing one or more advantages to using the products and/or methods disclosed herein.

### SUMMARY

As well as the embodiments discussed in the summary, other embodiments are disclosed in the specification, drawings, and claims. The summary is not meant to cover each and every embodiment; combination or variations are contemplated with the present disclosure.

In some embodiments the present disclosure is directed to non-dairy analogs where at least a portion of the protein used in the non-dairy analog is a succinylated refined protein, wherein the presence of the succinylated refined protein results in increased solubility, stability of the non-dairy analog when used as a substitute in a dairy product (e.g., yogurt, sour cream, creamers, and cheeses). In some embodiments, the non-dairy analog wherein at least a portion of the protein used in the non-dairy analog is a succinylated refined protein, is a creamer and exhibits reduced feathering when added to beverages (for example acidic beverages such as coffee or tea). The non-dairy analogs of the present disclosure, wherein at least a portion of the protein used in the non-dairy analog is a succinylated refined protein and provides improved solubility and stability, may be used as a non-dairy ingredient in a range of other food products, for example, yogurts, sour cream, milk, creamers, creams, and cheeses.

In some embodiments the present disclosure is directed to a non-dairy analog, the non-dairy analog comprising: (a) a refined protein component in which at least a portion of the refined protein component is a succinylated refined protein component; (b) at least one lipid in which the at least one lipid is from a non-animal natural source; (c) at least one emulsifier; (c) water; and (d) a pH of between 4.0 and 10; optionally, a pH between 6.5 and 10.

In some embodiments the present disclosure is directed to a non-dairy analog, the non-dairy analog comprising: (a) at least 2% by weight of a refined protein component in which at least 30% by weight of the refined protein component is a succinylated refined protein component; (b) between 1% by weight and 10% by weight of at least one lipid in which the at least one lipid is from a non-animal natural source; (c) between 0.01% by weight and 10% by weight of at least one emulsifier; (d) water; and (e) a pH of between 4.0 and 10; optionally, a pH between 6.5 and 10.

In some embodiments the present disclosure is directed to a non-dairy analog wherein the refined protein component comprises is at least 1%, 2%, 3%, 5%, 8% or 10% by weight of the non-dairy analog; optionally, between 2% to 5%, 3% to 4%, 1% to 10%, 3% to 8% or 2% to 4% by weight of the non-dairy analog.

In some embodiments the present disclosure is directed to a non-dairy analog wherein the wherein the succinylated refined protein component is at least 30%, 40%, 50%, 60%, 70%, 80%, 90% or 100% by weight of the total weight of the refined protein component; optionally, wherein the succinylated refined protein component is between 30% to 100%, 40% to 100%, 40% to 60%, 40% to 70% or 30% to 50% by weight of the total weight of the refined protein component.

In some embodiments the present disclosure is directed to a non-dairy analog wherein the succinylated refined protein component is succinylated by succinic anhydride treatment; optionally, wherein the succinic anhydride treatment comprises at least 5%, 10%, 20%, 30%, 40%, or at least 50% by weight succinic anhydride relative to refined protein.

In some embodiments the present disclosure is directed to a non-dairy analog wherein the refined protein component is sourced from a plant; optionally, sourced from a legume. Certain embodiments are directed to a non-dairy analog wherein the refined protein component is sourced from a pea plant or a pea protein.

In some embodiments the present disclosure is directed to methods are for producing the non-dairy analog may comprise one or more of the following steps, in or out of order: a) obtaining at least one lipid from a non-animal natural source; b) obtaining at least one refined protein component from a non-animal natural source in which at least a portion of the refined protein component is a succinylated refined protein component; c) blending the at least one lipid and the at least one refined protein component with water to generate a mixture; and d) emulsifying at least a portion of the mixture to provide a non-dairy analog; whereby the quantities and proportions of the at least one lipid, and the at least one refined protein components are selected so as to provide a desired stability and/or solubility of the non-dairy analog.

In some embodiments, the present disclosure provides a beverage formulation, wherein the formulation comprises: (a) a refined protein component in which at least a portion of the refined protein component is a succinylated refined protein component; (b) water or carbonated water; and (c) a pH of between 6 and 9.

In some embodiments of the beverage formulation, the formulation further comprises: (a) sugar and/or a carbohydrate; (b) at least one vitamin or mineral; (c) at least one lipid from a non-animal natural source; and/or (d) at least one emulsifier, and/or a hydrocolloid or gum. In some embodiments, the beverage formulation is selected from: a protein drink, a vitamin drink, a fruit juice drink, or an iced tea drink.

In some embodiments of the beverage formulation, the succinylated refined protein component is at least 30%, 40%, 50%, 60%, 70%, 80%, 90% or 100% by weight of the total weight of the refined protein component. In some embodiment, the refined protein component comprises is at least 1%, 2%, 3%, 5%, 8% or 10% by weight of the beverage formulation.

In some embodiments of the beverage formulation, the beverage: (a) exhibits less than 5%, 3%, 1% or 0.5% by weight precipitation of the refined protein component; and/or (b) exhibits less than 5%, 3%, 1% or 0.5% by volume precipitation of the refined protein component.

In some embodiments of the beverage formulation, the refined protein component is sourced from a plant; optionally, sourced from a legume. In some embodiments, the refined protein component is sourced from a pea plant or a pea protein.

### BRIEF DESCRIPTION OF THE DRAWINGS

Embodiments of the present disclosure are described, by way of example only, with reference to the accompanying figures.

FIG. 1 illustrates protein solubility at varied pH of control (unmodified) and succinylated pea protein extracts, according to certain embodiments.

FIG. 2 shows images of control (unmodified) protein non-dairy analog (left) that had instant feathering and settling in coffee as compared with succinylated (modified) protein non-dairy analog (right) embodiments that had no feathering or settling.

FIG. 3 shows images taken 5 minutes after addition of non-dairy analog to coffee. From left to right the control non-dairy analog ratio is decreasing from 100-0%, while embodiments with the succinylated protein non-dairy analog ratio is increasing from 0-100%. In this example, once the sample reached 6:4 (60% unmodified (control) and 40% succinylated (modified) non-dairy analog), feathering in coffee, based on visual inspection was eliminated.

FIG. 4 depicts plots of percentage protein solubility relative to pH for succinylated refined pea protein prepared by treatment with 20 wt % succinic anhydride at pH 7, 8.5, and 10.

FIG. 5 depicts plots of percentage protein solubility relative to pH for succinylated refined pea protein prepared by succinic anhydride treatment of the protein at pH 10 with the following weight percentages of succinic anhydride: 5 wt %, 7.5 wt %, 10 wt %, 20 wt %, 35 wt %, and 50 wt %.

FIG. 6 depicts plots of percentage protein solubility relative to pH for succinylated refined pea protein prepared by precipitation at pH 3 relative and unmodified (control) refined pea protein prepared by precipitation at pH 5.5, as described in Example 7.

FIG. 7 depicts plots of percentage protein solubility relative to pH for succinylated refined pea protein or unmodified pea protein prepared from a spray-dried pea protein isolate as described in Example 8.

FIG. 8 depicts plots of percentage protein solubility relative to pH for the succinylated refined pea protein prepared from a spray-dried pea protein isolate relative to a control unmodified pea protein isolate prepared similarly as described in Example 9.

FIG. 9 depicts plots of relative foaming expansion values over time for a succinylated refined pea protein relative to a control unmodified pea protein measured as described in Example 9.

FIG. 10 depicts images taken 5 minutes after mixing of an unmodified (control) non-dairy analog mixed in coffee (left image) and a succinylated non-dairy analog mixed in coffee (right image).

### DETAILED DESCRIPTION

For the descriptions herein and the appended claims, the singular forms “a”, and “an” include plural referents unless the context clearly indicates otherwise. Thus, for example, reference to “a protein” includes more than one protein. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. The use of “comprise,” “comprises,” “comprising” “include,” “includes,” and “including” are interchangeable and not intended to be limiting. It is to be further understood that where descriptions of various embodiments use the term “comprising,” those skilled in the art would understand that in some specific instances, an embodiment can be alternatively described using language “consisting essentially of” or “consisting of.”

Where a range of values is provided, unless the context clearly dictates otherwise, it is understood that each intervening integer of the value, and each tenth of each intervening integer of the value, unless the context clearly dictates otherwise, between the upper and lower limit of that range, and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding (i) either or (ii) both of those included limits are also included in the invention. For example, “1 to 50,” includes “2 to 25,” “5 to 20,” “25 to 50,” “1 to 10,” etc.

Generally, the nomenclature used herein and the techniques and procedures described herein include those that are well understood and commonly employed by those of ordinary skill in the art. Unless defined otherwise, all technical and scientific terms used herein have the same meaning as is commonly understood by one of ordinary skill in the art to which this disclosure pertains. It is to be understood that the terminology used herein is for the purpose of describing particular embodiments only and is not intended to be limiting. For purposes of interpreting this disclosure, the following description of terms will apply and, where appropriate, a term used in the singular form will also include the plural form and vice versa.

### Definitions

The term “dairy milk” as used herein refers to a white fluid secreted by the mammary glands of female mammals Dairy milk consists of an emulsion of fat in an aqueous solution comprising proteins (e.g., casein, albumin), sugars, inorganic salts, and other ingredients. Suitable mammals from which dairy milk can be obtained include but are not limited to cow, sheep, goat, buffalo, donkey, horse, camel, yak, water buffalo, human, and other mammals Dairy milk obtained from cow typically contains around 3.5% fat (whole cow milk) Fat levels can be reduced to standardized levels to obtain different grades of cow milk that comprise from 0% to 75% by weight of the fat present in whole cow milk, including but not limited to 2% cow milk (cow milk comprising 2% by weight of fat), 1% cow milk (cow milk comprising 1% by weight of fat), and skim cow milk (cow milk comprising no fat).

The term “non-dairy analog” as used herein refers to a food product that can be used as a substitute for a dairy product but that is made from a non-dairy natural source and/or a modified natural source. Non-dairy analogs are produced to have one or more of the following qualities that are similar or substantially similar to the qualities of comparable dairy products (such as dairy milk or dairy cream): color, taste, nutritional content, stability and/or solubility. Non-limiting examples of applications of non-dairy analogs is in yogurts, puddings, ice creams, coffee creamers, heavy creams, whipping creams, sour creams, soft cheeses, hard cheeses or other suitable products in which a non-dairy analog may be used. One non-limiting application of non-dairy analogs exemplified in the present disclosure is as a substitute for milk or cream that may be used with tea, coffee, hot chocolate, or other beverages. As described elsewhere herein, in some embodiments at least a portion of the refined protein used in the non-dairy analogs is a succinylated refined protein.

The term “protein concentrate” as used herein refers to the protein material that is obtained from a natural source and/or modified natural source upon removal of at least a portion of (or a substantial portion of) one or more of the following: carbohydrate, ash, and other minor constituents. It typically comprises at 40% to 70% by weight of protein.

The term “protein isolate” as used herein refers to the protein material that is obtained from a natural source and/or modified natural source upon removal of at least a portion of (or a substantial portion of) one or more of the following: insoluble polysaccharide, soluble carbohydrate, ash, and other minor constituents. It typically has at least 70% by weight of protein.

The terms “refined protein component” or “refined protein” as used herein refers to a protein preparation derived from a natural source and/or modified natural source that contains protein. The term encompasses protein isolate, protein concentrate, flour, meal and/or combinations thereof. In exemplary embodiments of non-dairy analogs of the present disclosure at least a portion of the refined protein component or refined protein is a succinylated refined protein component or succinylated refined protein.

The term “succinylated protein” or “succinylated refined protein” as used herein refers to a protein preparation chemically modified by treatment with a succinylating reagent (e.g., succinic anhydride). Such modification results in a protein having one or more lysine residues with a succinate group (—CO—CH₂—CH₂—CO₂⁻) attached to its ε-amine nitrogen atom. Although some naturally-occurring biological processes can result in succinylated lysine residues, succinylated protein, as used herein, is intended to encompass only proteins modified by in vitro treatment with a non-naturally occurring succinylating reagent, such as succinic anhydride.

The terms “stable,” “solubilized” and “soluble” as used herein when referring to a non-dairy analog mixed in a composition (e.g., an aqueous composition such as coffee or tea) means that the mixture has a uniform, or substantially uniform appearance, and may include an insubstantial amount of visible precipitation, or no visible precipitation. It is also to be understood that uniform, or substantially uniform, does contemplate some permitted variation in the color of the mixture or in portions of the mixture.

The term “feathering” as used herein means the presence of particles due at least in part to flocculation or protein aggregation (instability) occurring when the non-dairy analog is dispersed in a beverage.

The terms “a” and “an” and “the” and similar referents as used herein refer to both the singular and the plural, unless otherwise indicated herein or clearly contradicted by context.

The term “about” as used herein refers to greater or lesser than the value or range of values stated by 1/10 of the stated values, but is not intended to limit the value or range of values to only this broader definition. For instance, a value of “about 30%” means a value of between 27% and 33%. Each value or range of values preceded by the term “about” is also intended to encompass the embodiment of the stated absolute value or range of values.

As used herein, the term “comprising” means “including.” Variations of the word “comprising”, such as “comprise” and “comprises,” have correspondingly varied meanings. Thus, for example, a method “comprising” steps ‘A’ and ‘B’ may consist exclusively of steps ‘A’ and ‘B’ or may include one or more additional steps (e.g., steps ‘A’, ‘B’, and ‘C’).

The ingredients of the non-dairy analogs provided herein, such as the refined protein component, may be derived from one or more non-animal natural and/or one or more non-animal modified natural sources. Suitable natural sources are naturally occurring plants, algae, fungi, or microbes.

Examples of suitable plants include, but are not limited to, vegetable plants (e.g., carrot, celery), sunflower, potato, sweet potato, tomato, blueberry, nightshades, buckwheat, amaranth, chard, quinoa, spinach, hazelnut, canola, kale, bok choy, rutabaga, hemp, pumpkin, squash, legume plants (e.g., alfalfa, lentils, beans, clovers, peas, soybean, peanut, chickpea, green pea, yellow pea, snow pea, lima bean, fava bean), cotton, fruiting plants (e.g., apple, apricot, peach, plum, pear, nectarine), strawberry, blackberry, raspberry, cherry, citrus (e.g., grapefruit, lemon, lime, orange, bitter orange, mandarin), mango, grape, broccoli, brussels, sprout, rapeseed (canola), turnip, cabbage, cucumber, watermelon, honeydew melon, zucchini, cassava, baobab, almond, macadamia, taro, barley, corn, oat, palm, rice, rye, sorghum, triticale, moringa, grain plants, leafy vegetables, non-grain legume plants, millets, green algae, derivatives and crosses thereof or combinations thereof. In certain embodiments, examples of suitable plants may be selected from one or more of the following: peas, flaxseed, soybeans, lentils, lupin, fava bean, chickpea, sunflower, rapeseed, sugar cane, sugar beet, oat, wheat and corn. In certain embodiments, the suitable plant may be peas, for example yellow peas. In certain embodiments, the suitable plant may be flaxseed. In certain embodiments, the suitable plant may be soybeans. In certain embodiments, the suitable plant may be lentils. In certain embodiments, the suitable plant may be lupins. In certain embodiments, the suitable plant may be fava beans. In certain embodiments, the suitable plant may be chickpeas. In certain embodiments, the suitable plant may be sunflower. In certain embodiments, the suitable plant may be rapeseed. In certain embodiments, the suitable plant may be sugar cane. In certain embodiments, the suitable plant may be sugar beet. In certain embodiments, the suitable plant may be oat. In certain embodiments, the suitable plant may be wheat. In certain embodiments, the suitable plant may be corn.

Examples of suitable algae include, but are not limited to: viridiplantae, stramenopiles, rhodophyta, chlorophyta, PX, flordeophyceae, bangiophyceae, florideohpyceae, trebouxiophyceae, phaeophyceae, palmariales, gigartinales, bangiales, gigartinales, Chlorella, Laminaria japonica, Laminaria saccharina, Laminaria digitata, Macrocystis pyrifera, Alaria marginata, Ascophyllum nodosum, Ecklonia sp., Palmaria palmata, Gloiopeltis furcata, Porphyra columbina, Gigartina skottsbergii, Gracilaria lichenoides, Chondrus crispus, Gigartina bursa-pastoris, derivatives and crosses thereof or combinations thereof. In certain embodiments, examples of suitable algae may be selected from one or more of the following: Pyropia, Spirolina, rhodophyta, chlorphyta, and chlorella.

Examples of suitable fungi include but are not limited to Pichia pastoris, Saccharomyces cerevisiae, Saccharomyces pombe, derivatives and crosses thereof or combinations thereof. In certain embodiments, examples of suitable fungi may be selected from one or more of the following: Saccharomyces sp., Pichia pastoris, Hansunula polymorpha, Aexula adeninivorans, Kluyveromyces lactis, Yarrowia lipolytica, and Schizosaccaromyces pombe. In certain embodiments, a suitable fungus may be Saccharomyces cerevisiae. Examples of suitable microbes include but are not limited to firmicutes, cyanobacteria (blue-green algae), bacilli, oscillatoriales, bacillales, lactobacillales, oscillatoriales, bacillaceae, lactobacillaceae, arthrospira, Bacillus coagulans, Lactobacillus acidophilus, Lactobacillus Reuteri, Spirulina, Arthrospira platensis, Arthrospira maxima, derivatives and crosses thereof or combinations thereof. In certain embodiments, examples of suitable microbes may be selected from one or more of the following: Escherichia coli, Lactobacillus sp., and Cornybacterium glutamicum. In certain embodiments, a suitable microbe may be a protist, such as Euglena spp.

Non-animal natural sources may be obtained from a variety of sources including, but not limited to, nature (e.g., lakes, oceans, soils, rocks, gardens, forests, plants, animals), brewery stores, and commercial cell banks (e.g., ATCC, collaborative sources). Modified non-animal natural sources may be obtained from a variety of sources including but not limited to brewery stores and commercial cell banks (e.g., ATCC, collaborative sources), or can be generated from natural sources by methods known in the art, including selection, mutation, or gene manipulation. Selection generally involves continuous multiplication and steady increase in dilution rates under selective pressure. Mutation generally involves selection after exposure to mutagenic agents. Gene manipulation generally involves genetic engineering (e.g., gene splicing, insertion of deletions or modifications by homologous recombination) of target genes. A modified natural source may produce a non-native protein, carbohydrate, lipid, or other compound, or produce a non-native amount of a native protein, carbohydrate, lipid, or other compound. In some embodiments, the modified natural source expresses higher or lower levels of a native protein or metabolic pathway compound. In other such embodiments, the modified natural source expresses one or more novel recombinant proteins, RNAs, or metabolic pathway components derived from another plant, algae, microbe, or fungus. In other embodiments, the modified natural source has an increased nutraceutical content compared to its native state. In yet other embodiments, the modified natural source has more favorable growth and production characteristics compared to its native state. In some such embodiments, the modified non-animal natural source has an increased specific growth rate compared to its native state. In other such embodiments, the modified non-animal natural source may utilize a different carbon source than its native state.

In some embodiments, the protein, lipid, carbohydrate, or other ingredients of the non-dairy analogs provided herein are derived from byproducts of previously processed one or more non-animal natural or modified non-animal natural sources. Examples of such byproducts include, but are not limited to, deoiled meal (e.g., deoiled flaxseed meal, deoiled soybean meal, deoiled sunflower meal, deoiled canola meal, or combinations thereof).

Non-Dairy Analogs Containing Succinylated Refined Protein

Certain embodiments of the present disclosure are directed to a non-dairy analog that comprises a refined protein component obtained substantially from or wholly from non-animal natural products, wherein at least a portion of the refined protein used in the non-dairy analogs is a succinylated refined protein. The non-dairy analogs comprising the succinylated protein has stability and/or solubility qualities improved relative to non-dairy analogs without succinylated protein and similar in quality to comparable dairy products. It is a surprising effect of the non-dairy analog compositions and formulations of the present disclosure that the inclusion of succinylated refined proteins (e.g., refined pea protein) in non-dairy analogs (e.g., non-dairy milk), improves their stability and/or solubility of the refined plant protein within acidic beverages such as coffee. In contrast, non-dairy analogs that do not include the succinylated refined protein (e.g., only unmodified refined pea protein isolate) exhibited substantial feathering and/or precipitation when mixed with an acidic beverage such as coffee. Succinylated refined proteins (e.g., pea protein) when included within the same non-dairy analog are stable, do not feather, and/or precipitate when mixed with an acidic beverage such as coffee.

In certain embodiments, at least 95% by weight of the non-dairy analog is solubilized in an aqueous composition, wherein the aqueous composition is between 30° C. and 95° C. and has an aqueous composition pH that is less than 7, before the non-dairy analog is combined with the aqueous composition or after the non-dairy analog is combined with the aqueous composition.

In certain embodiments, the non-dairy analog is solubilized, or substantially solubilized, in an aqueous composition for at least 5 minutes, 10 minutes, or 15 minutes after at least partial mixing of the non-dairy analog composition with the aqueous composition.

In certain embodiments, at least 90%, or at least 95%, by weight of the non-dairy analog composition is stable in an aqueous composition for at least 5 minutes, 10 minutes, or 15 minutes after at least partial mixing of the non-dairy analog composition with the aqueous composition.

In certain embodiments, at least 90%, or at least 95%, by weight of the non-dairy analog composition is stable in the aqueous composition for at least 5 minutes, 10 minutes, or 15 minutes after at least partial mixing of the non-dairy analog composition with the aqueous composition.

In certain embodiments, the non-dairy analog does not visibly precipitate when added to an aqueous composition for at least 5 minutes, 10 minutes, or 15 minutes after at least partial mixing of the non-dairy analog composition with the aqueous composition.

In certain embodiments, the non-dairy analog exhibits insubstantial precipitation when added to an aqueous composition for at least 5 minutes, 10 minutes, or 15 minutes after at least partial mixing of the non-dairy analog composition with the aqueous composition.

In certain embodiments, the non-dairy analog is capable of exhibiting less than 5%, 3%, 1% or 0.5% by weight precipitation when added to the aqueous composition after at least partial mixing of the non-dairy analog with the aqueous composition.

In certain embodiments, the non-dairy analog is capable of not visibly feathering when added to the aqueous composition for 15 minutes, 10 minutes, or 5 minutes after at least partial mixing of the non-dairy analog with the aqueous composition.

In certain embodiments, the succinylated refined protein component is capable of increasing the total solubility of the refined protein component by at least 10%, 20%, 50%, 60% or 70% when the non-dairy analog is combined with the aqueous composition, wherein the aqueous composition pH of the aqueous composition is between 3 to 10, before the non-dairy analog is combined with the aqueous composition or after the non-dairy analog is combined with the aqueous composition.

In certain embodiments, the succinylated refined protein component is capable of increasing the total solubility of the refined protein component by at least 10%, 20%, 50%, 60% or 70% when the non-dairy analog is combined with the aqueous composition, wherein the aqueous composition pH of the aqueous composition is less than 7, before the non-dairy analog is combined with the aqueous composition or after the non-dairy analog is combined with the aqueous composition.

In certain embodiments, the succinylated refined protein component is capable of increasing the total solubility of the refined protein component by at least 10%, 20%, 50%, 60% or 70% when the non-dairy analog is combined with the aqueous composition, wherein the aqueous composition pH of the aqueous composition is between 3 and 6, before the non-dairy analog is combined with the aqueous composition.

In certain embodiments, the succinylated refined protein component is capable of increasing the total solubility of the refined protein component by at least 10%, 20%, 50%, 60% or 70% when the non-dairy analog is combined with the aqueous composition, wherein the aqueous composition has a temperature of between 30° C. and 95° C. and an aqueous composition pH of between 3 to 10, before the non-dairy analog is combined with the aqueous composition or after the non-dairy analog is combined with the aqueous composition.

In certain embodiments, the succinylated refined protein component is capable of increasing the total solubility of the refined protein component by at least 10%, 20%, 50%, 60% or 70% when the non-dairy analog is combined with the aqueous composition, wherein the aqueous composition has a temperature of between 30° C. and 95° C. and an aqueous composition pH of less than 7, before the non-dairy analog is combined with the aqueous composition.

In certain embodiments, the succinylated refined protein component is capable of increasing the total solubility of the refined protein component by at least 10%, 20%, 50%, 60% or 70% when the non-dairy analog is combined with the aqueous composition, wherein the aqueous composition has a temperature of between 30° C. and 95° C. and an aqueous composition, before the non-dairy analog is combined with the aqueous composition pH of between 3 and 6.

In some embodiments, the non-dairy analogs provided herein are analogs of dairy milk. In other embodiments, the non-dairy analogs are analogs of dairy cream type products derived from dairy milk. In some embodiments, the non-dairy analogs are primarily, substantially, or entirely composed of ingredients derived from non-animal natural sources. In alternative embodiments, the non-dairy analogs are composed of ingredients partially derived from animal sources but supplemented with ingredients derived from non-animal natural sources.

In certain embodiments, the amount of refined protein used in the non-dairy analog may vary. In certain embodiments, the refined protein component is at least 1%, 4%, 4.5%, 5%, 10%, 15% or 20% by weight of the total weight of the non-dairy analog. In certain embodiments, the refined protein component is between 1% and 20%, 4% and 10%, 3% and 5%, 2% and 6%, 4% and 5%, 5% and 15% or 10% and 16% by weight of the total weight of the non-dairy analog. In some embodiments, the ratio of protein to lipid in the non-dairy analogs is 1:5, 1:4, 1:3, 1:2, 1:1, 2:1, 3:1, 4:1, 5:1, or 10:1. Protein content of a food product may be determined by a variety of methods, including, but not limited to, AOAC International reference methods AOAC 990.03 and AOAC 992.15, and combustion analysis (ISO 14891:2008).

In certain embodiments, the amount of refined protein used in the non-dairy analog may vary. In certain embodiments, the refined protein component is at least 1%, 4%, 4.5%, 5%, 10%, 15% or 20% by weight of the total weight of the non-dairy analog. In certain embodiments, the refined protein component is between 1% and 20%, 4% and 10%, 4% and 5%, 5% and 15% or 10% and 16% by weight of the total weight of the non-dairy analog.

In the non-dairy analog embodiments disclosed herein, the amount of succinylated refined protein used in the refined protein component may vary. In certain embodiments, the succinylated refined protein component is at least 30%, 40%, 50%, 70%, 80%, 90% or 100% by weight of the total weight of the refined protein component used in the non-dairy analog. In certain embodiments, the succinylated refined protein component is between 30% to 100%, 40% to 60%, 30% to 50%, 40% to 70%, 50% to 80%, 70% to 90% or 35% to 45% by weight of the total weight of the refined protein component used in the non-dairy analog.

There are various available methods for succinylating plant proteins useful in the embodiments of the present disclosure, including methods using the succinylating reagent, succinic anhydride, as described in Example 1, and other the examples disclosed herein. The amount of succinylation of the refined protein may be varied. In certain embodiments, the amount of refined protein succinylated may be at least 20%, 30%, 40%, 50%, 60%, 70%, 80%, 90%, 95%, 98%, 99%, or 100% by weight of the total weight of refined protein. In certain embodiments, the amount of refined protein succinylated may be between 40% to 60%, 45% to 55%, 20% to 70%, 30% to 80%, 35% to 90%, 20% to 60% or 40% to 100% by weight of the total weight of the refined protein.

The non-dairy analogs provided herein may further comprise lipids. In some embodiments, the dairy product analogs comprise between 1% and 10%, between 0.5% and 8%, between 1% and 7%, between 5% and 20%, between 10% and 25% or between 5% and 10% by weight of lipids obtained from non-animal natural sources. Lipid content of a food product may be determined by a variety of methods, including, but not limited to, AOAC International reference method AOAC 954.02. Examples of suitable lipids include, but are not limited to, almond oil, aloe vera oil, apricot kernel oil, avocado oil, baobab oil, calendula oil, canola oil, corn oil, cottonseed oil, evening primrose oil, grape oil, grape seed oil, hazelnut oil, jojoba oil, linseed oil, macadamia oil, natural oils, neem oil, non-hydrogenated oils, olive oil, palm oil, partially hydrogenated oils, peanut oil, rapeseed oil, sesame oil, soybean oil, sunflower oil, synthetic oils, vegetable oil), omega-fatty acids (e.g., arachidonic acid, omega-3-fatty acids, omega-6-fatty acids, omega-7-fatty acids, omega-9-fatty acids), or combinations thereof. In certain embodiments, examples of suitable lipids may be selected from one or more of the following: sunflower oil, coconut oil, sunflower lecithin, palm oil or combinations thereof. In certain embodiments, the lipid may be sunflower oil. In certain embodiments, the lipid may be sunflower lecithin. In certain embodiments, the lipid may be palm oil. In certain embodiments, the lipid may be coconut oil. In certain embodiments, the lipid may be soy lecithin.

In some embodiments, the non-dairy analogs provided herein comprise similar, substantially similar, or reduced amounts of carbohydrate as analogous dairy products. Carbohydrate content of a food product may be determined by a variety of methods, including, but not limited to, high performance liquid chromatography. Examples of suitable carbohydrates include, but are not limited to, sucrose, glucose, fructose, mannose, steviosides, artificial sweeteners, monk fruit extract or combinations thereof. In certain embodiments, examples of suitable carbohydrates may be selected from one or more of the following: sucrose, glucose, and fructose. In certain embodiments, the carbohydrate may be monk fruit extract. In certain embodiments, the carbohydrate may be sucrose. In certain embodiments, the carbohydrate may be fructose. In certain embodiments, the carbohydrate may be artificial sweeteners. In some embodiments, the non-dairy analogs comprise between 0.5% and 15%, between 1% and 10%, or between 3% and 8% by weight of carbohydrate. In some embodiments, the dairy product analog comprises at least 0.5%, 1%, 3%, 5%, 8% 10% or 15% by weight of carbohydrate. In some embodiments, the non-dairy analogs comprise 30%, 40%, 50%, 60%, or 70% by weight less total carbohydrate than in an equivalent sized serving of non-dairy analog, regardless of fat content. In some embodiments, the non-dairy analogs do not comprise lactose. In some embodiments, the non-dairy analogs contain less than 5%, 3%, 1%, or 0.5% by weight of lactose. In some embodiments, the non-dairy analogs comprise sucrose.

Various protein sources may be used in one or more of the disclosed embodiments. Examples of protein sources include, but are not limited to, melon, barley, coconut, rice, pear, emmer, carrot, lupin seeds, pea, fennel, lettuce, oat, cabbage, celery, soybeans, almond, rice, flax, potato, sunflower, mushroom, or combinations thereof. Other suitable plants and/or protein sources may also be used.

The protein of the plant may be derived from a legume. Examples of legumes include, but are not limited to, alfalfa, lentils, beans, clovers, peas, fava coceira, frijole bola roja, frijole negro, lespedeza, licorice, lupin, mesquite, carob, soybean, peanut, tamarind, wisteria, cassia, chickpea, garbanzo, fenugreek, green pea, yellow pea, snow pea, lima bean, fava bean, black bean, baby bean or combinations thereof. In certain embodiments, the legumes may be selected from peas. In certain embodiments, the legume may be yellow pea. In certain embodiments, the legume may be green pea. In certain embodiments, the legume may be lentils. In certain embodiments, the legume may be chickpeas. In certain embodiments, the legume may be lupin. In certain embodiments, the legume may be fava beans.

Flavorings may also be used in certain embodiments of the non-dairy analogs disclosed herein. Examples, of flavorings include, but are not limited to, chocolate, toffee, almond, truffles, cinnamon, eggnog, caramel, sugar, butter pecan, hazelnut, pumpkin spice, peppermint, coconut, French vanilla or combinations thereof. In certain embodiments, natural sweetness enhancers may be used.

Beverage Formulations Containing Succinylated Refined Protein

As described above, non-dairy analogs containing a succinylated refined protein component exhibit improved qualities of improved solubility and decreased visible precipitation of the protein component when mixed in an aqueous beverage such as coffee or tea. These improved qualities also extend to the use of a succinylated refined protein component in other protein-containing beverage formulations. A wide range of beverage formulations incorporate a significant portion of a refined protein component in an aqueous mixture. Such protein-supplemented beverage formulations include but are not limited to, protein drinks, post-work-out drinks, vitamin drinks, exercise drinks, electrolyte drinks, fruit juice drinks, and iced tea drinks. It is contemplated that the beverage formulations comprising a succinylated refined protein component can be used for any aqueous beverage that is supplemented with a plant protein. Generally, it is highly desirable to minimize any precipitation of a refined protein component in such beverages because consumers generally prefer a substantially transparent beverage without gritty or chalky solids present.

Accordingly, in some embodiments, the present disclosure provides a beverage formulation, wherein the formulation comprises: (a) a refined protein component in which at least a portion of the refined protein component is a succinylated refined protein component; (b) water or carbonated water; and (c) a pH of between 6 and 9.

In some embodiments of the beverage formulation, the refined protein component is sourced from a plant; optionally, sourced from a legume. In some embodiments, the refined protein component is sourced from a pea plant or a pea protein. Generally, the wide range of plant proteins described elsewhere herein as useful with non-dairy analogs can also be used as a refined protein component in the beverage formulations of the present disclosure.

In some embodiments the beverage formulation can comprise additional ingredients selected from: (a) sugar and/or a carbohydrate; (b) at least one vitamin or mineral; (c) at least one lipid from a non-animal natural source; and/or (d) at least one emulsifier, and/or a hydrocolloid or gum. Generally, the ingredients described elsewhere herein as useful with non-dairy analogs (e.g., carbohydrates, emulsifiers, lipids, etc.) can be used as ingredients in the beverage formulations of the present disclosure.

As described elsewhere herein for non-dairy analogs, it is an advantage of the beverage formulations of the present disclosure that the succinylation of a portion of the refined protein component (e.g., using 0.2 g succinic anhydride per g protein) greatly improves the protein solubility and precipitation related qualities of the beverage. In some embodiments the improved protein solubility qualities of the beverage formulation: (a) exhibits less than 5%, 3%, 1% or 0.5% by weight precipitation of the refined protein component; and/or (b) exhibits less than 5%, 3%, 1% or 0.5% by volume precipitation of the refined protein component.

These improved protein solubility qualities of the beverage formulations of the present disclosure are increasingly important in beverage formulation comprising substantial amount of protein. In some embodiments of the beverage formulations it is contemplated that the refined protein component comprises is at least 1%, 2%, 3%, 5%, 8% or 10% by weight of the beverage formulation.

As described with respect non-dairy analogs, the amount of succinylated refined protein used in a beverage formulation can be varied depending on the particular beverage application. For example, a high-protein post-workout beverage formulation may require a higher level of succinylated refined protein component in order to keep overall protein solubility desire levels. Accordingly, in some embodiments of the beverage formulation, the succinylated refined protein component is at least 30%, 40%, 50%, 60%, 70%, 80%, 90% or 100% by weight of the total weight of the refined protein component.

Methods for Producing Non-Dairy Analogs and Beverage Formulations

In certain embodiments, the present disclosure provides compositions, formulations, and methods for producing the non-dairy analogs and beverage formulations that contain a succinylated refined protein component. General methods, compositions, and formulations useful for preparing the non-dairy analogs and beverage formulations of the present disclosure are known in the art. See e.g., WO2017/120597A1, published Jul. 13, 2017, which is hereby incorporated by reference herein. Additional compositions, formulations, and methods of preparation are described elsewhere herein. See e.g., Table 1 and Example 5, which describes compositions and ranges of ingredients useful in the non-dairy analogs of the present disclosure.

In some embodiments, the methods for producing the non-dairy analog may comprise one or more of the following steps, in or out of order:

a) obtaining at least one lipid from a non-animal natural source;

b) obtaining at least one refined protein component from a non-animal natural source in which at least 30% by weight of the refined protein component is a succinylated refined protein component;

c) blending the at least one lipid and the at least one refined protein component with water to generate a mixture; and

d) emulsifying at least a portion of the mixture to provide a non-dairy analog;

whereby the quantities and proportions of the at least one lipid, and the at least one refined protein components are selected so as to provide a desired stability and/or solubility and the non-dairy analog has a pH of between 4.0 and 10. In some embodiments, the non-dairy analog can have a pH of between 6.5 and 10.

In some embodiments, the methods for producing the non-dairy analog may comprise one or more of the following steps, in or out of order:

a) obtaining at least one lipid from a non-animal natural source;

b) obtaining at least one refined protein component from a non-animal natural source in which at least a portion of the refined protein component is a succinylated refined protein component;

c) blending the at least one lipid and the at least one refined protein component with water to generate a mixture; and

d) emulsifying at least a portion of the mixture to provide a non-dairy analog;

whereby the quantities and proportions of the at least one lipid, and the at least one refined protein components are selected so as to provide a desired stability and/or solubility of the non-dairy analog.

In some embodiments, the methods are for producing the beverage formulation of the present disclosure include one or more of the following steps, in or out of order:
a) providing at least one refined protein component from a non-animal natural source in which at least 30% by weight of the refined protein component is a succinylated refined protein component;
b) providing at least one other ingredient selected from: (i) sugar and/or a carbohydrate; (ii) a vitamin or a mineral; (iii) a lipid from a non-animal natural source; (iv) an emulsifier; and/or (v) a hydrocolloid or a gum.
c) providing water or carbonated water; and
d) blending the at least one refined protein component and the at least one other ingredient with water to generate a mixture.

In preparing the beverage formulation, the quantities and proportions of the at least one refined protein component, including the amount of succinylated protein component, the other ingredients, and the water or carbonated water, can be selected so as to provide a desired stability and/or solubility a pH of between 6 and 9.

Methods for obtaining the at least one lipid from a non-animal natural are known in the art. Methods for obtaining the at least one refined protein component from a non-animal natural and/or modified non-animal natural source are provided herein. Other methods for obtaining the at least one refined protein component are known in the art. Methods for obtaining the succinylated refined protein component from a non-animal natural and/or modified non-animal natural source are provided herein. Other methods for obtaining the succinylated refined protein component are known in the art. In some embodiments, the lipid and/or refined protein component are obtained as slurries. In some embodiments, the lipid and/or refined protein component are obtained in solid form. In some embodiments, the refined protein component is combined with one or more other proteins prior to being mixed with the at least one lipid.

The at least one refined protein component may be added to the water as a dry, or substantially dry, solid or as a slurry. In certain embodiments, the at least one refined protein component as a dry, or substantially dry, solid may contain at least 50%, 60%, 70%, 80%, 90% by weight protein. In certain embodiments, the at least one refined protein component as a dry, or substantially dry, solid may contain between 50% to 100%, 70% to 90% or 80% to 100% by weight protein. In certain embodiments, the at least one refined protein component as a slurry may contain at least 3%, 5%, 10%, 20%, 30% or 40% by weight protein. In certain embodiments, the at least one refined protein component as a slurry may contain between 3% to 40%, 5% to 30%, 5% to 20% or 10% to 30% by weight protein.

The water or aqueous component may be an aqueous liquid, including but not limited to pure water, tap water, bottled water, deionized water, spring water, or a mixture thereof. The aqueous component may also contain suitable dissolved materials.

The lipid, protein, and aqueous components may be mixed in various orders. In some embodiments, the three components are mixed simultaneously. In other embodiments, the lipid is mixed with the protein component before the aqueous component is introduced into the mixture. In yet other embodiments, the protein component is mixed with the aqueous component before the lipid is introduced into the mixture. In yet other embodiments, the lipid is mixed with the aqueous component before the protein component is introduced into the mixture.

Combining the lipid, protein, and aqueous components may be accomplished using a variety of mixing devices, for example, mechanical agitators and/or pressure jets. The components may also be stirred or mixed by hand. Mixing may continue until the components are distributed substantially evenly throughout the mixture.

In some embodiments, a carbohydrate component may be also added. A variety of ingredients may be used as the carbohydrate component, including but not limited to starch, simple sugars, flour, edible fiber, and combinations thereof. Examples of suitable starches include but are not limited to maltodextrin, inulin, fructo oligosaccharides, pectin, carboxymethyl cellulose, guar gum, corn starch, oat starch, potato starch, rice starch, wheat starch, or combinations thereof. Examples of suitable flour include but are not limited to amaranth flour, oat flour, quinoa flour, rice flour, rye flour, sorghum flour, soy flour, wheat flour, corn flour, or combinations thereof. Examples of suitable edible fiber include but are not limited to barley bran, carrot fiber, citrus fiber, corn bran, soluble dietary fiber, insoluble dietary fiber, oat bran, pea fiber, rice bran, head husks, soy fiber, soy polysaccharide, wheat bran, wood pulp cellulose, or combinations thereof. In some embodiments, the carbohydrate component may be guar gum. In some embodiments, a carbohydrate component may be gellan gum. In some embodiments, a carbohydrate component may be a polysaccharide. In some embodiments, the carbohydrate component does not comprise lactose or substantially does not comprise lactose. The carbohydrate component may be present in the aqueous component before mixing. Alternatively, the carbohydrate component is added to the lipid and/or protein components or to the lipid, protein, and aqueous mixture.

Thickening agents may be used, including gelatin, pectin, agar, gums, starches, and ultra-gel. Examples of acceptable gums include sodium alginate, xanthan gum, guar gum or combinations thereof. Examples of acceptable starches include tapioca starch, arrowroot starch or combinations thereof. In some embodiments, the thickening agent may be a guar gum. In some embodiments, the thickening agent may be a gellan gum.

In some embodiments, one or more other ingredients are further added. In some such embodiments, the one or more other ingredients are added to the aqueous component before mixing. In other embodiments, the one or more other ingredients are added to the lipid and/or protein components or to the lipid, protein, and aqueous mixture. In some embodiments, the one or more other ingredients include calcium.

Emulsification may occur without additional mechanical energy, or require mechanical energy (for example, vortexing, homogenization, agitation, sonication, or other suitable mechanical activity). When emulsification is aided by lower amounts of mechanical energy (for example, agitation in a conventional mixer under moderate shear of between about 100 rpm and about 1,000 rpm), the average droplet size of the resulting emulsion is typically larger (for example, at least about 75% of the droplets have a diameter greater than about 25 um). When emulsification is aided by higher amounts of mechanical energy (e.g., homogenization in a high-pressure [for example, between about 35 bar and about 650 bar] 1- or 2-stage homogenizer [e.g., between about 1,000 rpm and about 10,000 rpm], or microfluidic homogenization [between about 500 and about 2,000 bar], the average droplet size of the resulting emulsion is typically smaller (for example, at least about 75% of the droplets have a diameter of less than about 10 um). Nanoemulsions may be obtained by homogenizing in a microfluidizer or other suitable equipment. In certain applications, to obtain higher lipid emulsions, the lipid component may be added gradually during mixing. Heating may aid in emulsification in certain applications. In some embodiments, emulsification is performed at greater than room temperature, greater than 30° C., 40° C., 50° C., 60° C., 70° C., or 80° C., between 90° C. and 120° C., between 30° C. and 60° C., or between 40° C. and 50° C. Heating is generally followed by cooling. Emulsification may be monitored by removing a sample of the mixture and analyzing it by such methods as microscopy, light scattering, and/or refractometry.

The emulsions may have droplets of various sizes. In some embodiments, the emulsions are polydisperse emulsions (i.e., emulsions comprising droplets with a broad distribution of droplet sizes). In other embodiments, the emulsions are monodisperse (i.e., emulsions comprising droplets with a narrow distribution of droplet sizes). In some embodiments, the emulsions are microemulsions (i.e., thermodynamic stable systems of dispersed droplets in continuous phase). In other embodiments, the emulsions are nanoemulsions (i.e., metastable [or kinetically stable] dispersions of one liquid in different immiscible liquid having droplet sizes ranging from 1 to 100 nm). In some embodiments, the emulsions have an average droplet size of less than about 1,000 nm, less than about 750 nm, less than about 500 nm, less than about 250 nm, less than about 100 nm, or less than about 50 nm, between about 100 nm and about 800 nm, or between about 100 nm and about 300 nm. In some embodiments, droplet sizes are reduced in order to reduce the lipid contents of the emulsions and non-dairy analogs provided herein. The degree of emulsification achieved and hence the final textures of the emulsions may be controlled to a certain degree by varying certain parameters during emulsification. Examples of such parameters include, but are not limited to, the type and/or amount of lipid component, the type and/or amount of protein component, the type and/or amount of optional emulsifiers, the amount of mechanical energy used during emulsification, the centrifugation or filtration techniques, the pH of the aqueous component, the temperature during mixing, the amount of optional salt in the aqueous component or combinations thereof.

In some embodiments, the non-dairy analog may be sterilized or pasteurized. Sterilization may occur by UV irradiation, heating (e.g. steam sterilization, flaming, or dry heating), or chemical sterilization (e.g., exposure to ozone). In some embodiments, sterilization kills more than 95% of microbes. For pasteurization, the non-dairy analog may be heated to a temperature (e.g., between about 280 and about 306° F.) and held at such temperature for a period of time (e.g., between about 1 and about 10 seconds). Appropriate pasteurization steps are known in the art of food manufacturing and may be undertaken at a variety of temperatures and/or for a variety of time durations. Pasteurization may be high-temperature, short-time (HTST), “extended shelf life” (ESL) treatment, high pressure pasteurization (HPP), ultra pasteurization (UP), ultra-high temperature (UHT) or combinations thereof. A controlled chilling system may be used to rapidly cool the non-dairy analog. In some embodiments, the non-dairy analogs undergo vacuum cooling to remove volatiles and water vapor following pasteurization.

The non-dairy analog may optionally be dried to obtain powders. Drying may be performed in a suitable way, including but not limited to spray drying, dry mixing, agglomerating, freeze drying, microwave drying, drying with ethanol, evaporation, refractory window dehydration or combinations thereof.

Refined Protein Components

In some embodiments, the refined protein component has a total protein content of at least 30%, 40%, 50%, 60%, 70% or 80% by dry weight.

In some embodiments, the refined protein component has a total protein content of between 30% and 90%, between 40% and 85%, between 50% and 90%, between 65% and 88%, between 70% and 86%, or between 75% and 86% by dry weight.

It some embodiments, the refined protein component has a total bound calcium content of at least 0.1%, 0.3%, 0.5%, 1%, 1.5%, 1.7% or 2% by dry weight.

It some embodiments, the refined protein component has a total bound calcium content of between 0.1% and 2%, between 0.3% and 1.7%, between 0.5% and 1.5%, or between 0.5% and 1% by dry weight.

In some embodiments, the refined protein component is a paste comprising between 4% and 25% by weight of protein, and between 0.1 and 1.5% by weight of calcium, and between 50% and 92% by weight of water. In some embodiments, the refined protein component is a dry powder comprising between 70% and 90% by weight of protein, and between 2% and 7% by weight of calcium.

One exemplary refined protein component has a composition of at least about 80% of visible protein bands on a denaturing protein gel with a molecular weight of less than 200 kDa, at least about 80% of visible protein bands on a denaturing protein gel with a molecular weight of less than 150 kDa on a denaturing protein gel, at least about 80% of visible protein bands on a denaturing protein gel with a molecular weight of between about 10 kDa and about 100 kDa.

Certain embodiments are directed to a refined protein (isolate and/or component) that may have one or more of the following characteristics:

A refined protein comprising between 5% to 97%, 20% to 90%, 30% to 85%, or 40% to 80%, by weight of a protein obtained from one or more non-animal natural sources. A refined protein comprising at least 5, 10, 20, 30, 40, 50, 60, 70, 80, 90% by weight of a protein obtained from one or more non-animal natural sources.

In certain embodiments, the refined protein may be a paste, a wet suspension or a dry powder.

In certain embodiments, the refined protein may have a dry solids weight percentage of at least 5, 10, 20, 30, 40, 50, 60, 70, 80, or 90%.

In certain embodiments, the refined protein may have a calcium to protein ratio is between 0.5% w/w to 5% w/w, 1% w/w to 6% w/w, 3% w/w to 8% w/w, or 5% w/w to 10% w/w.

In certain embodiments, the refined protein may be color neutral or not color neutral.

In certain embodiments, the refined protein may have a pH of between 3 and 11, 6.5 and 10, 5.5 and 8, or 5.7 to 6.7. In certain embodiments, the refined protein may have a pH of at least 3. In certain embodiments, the refined protein may have a pH of less than 9.

In certain embodiments, the refined protein may have a moisture content of between 3% and 90% by weight. In certain embodiments, the refined protein may have a moisture content of at least 4% by weight. In certain embodiments, the refined protein has a moisture content of less than 80% by weight.

In certain embodiments, the refined protein may have a fat content of between 1% and 30% by weight. In certain embodiments, the refined protein may have a fat content of at least 2% by weight. In certain embodiments, the refined protein may have a fat content of less than 25% by weight.

In certain embodiments, the refined protein may have a carbohydrate content of between 0% and 50% by weight. In certain embodiments, the refined protein may have a carbohydrate content of at least 0% by weight. In certain embodiments, the refined protein may have a carbohydrate content of less than 25% by weight.

In certain embodiments, the refined protein has a starch content of between 0% and 10% by weight. In certain embodiments, the refined protein has a starch content of at least 3% by weight. In certain embodiments, the refined protein has a starch content of less than 9% by weight.

In certain embodiments, the refined protein has a phosphorus content of between 0% and 6% by weight. In certain embodiments, the refined protein has a phosphorus content of at least 0.1% by weight. In certain embodiments, the refined protein has a phosphorus content of less than 4% by weight.

In certain embodiments, the refined protein has sodium and/or potassium content of less than 0.5% by weight.

In certain embodiments, the refined protein has an ash content of between 0% and 20% by weight. In certain embodiments, the refined protein has an ash content of at least 1% by weight. In certain embodiments, the refined protein has an ash content of less than 10% by weight.

In certain embodiments, the refined protein has a reducing capacity of between 5% and 50%. In certain embodiments, the refined protein has a reducing capacity of at least 6%. In certain embodiments, the refined protein has a reducing capacity of less than 46%.

In certain embodiments, the refined protein has a total HPLC peak area for total extractable soluble sugars and organic acids of between 20,000 and 250,000. In certain embodiments, the refined protein has a total extractable soluble sugars and organic acids of at least 22,000. In certain embodiments, the refined protein has a total extractable soluble sugars and organic acids of less than 240,000.

In certain embodiments, the refined protein has a total peak area measured by GC analysis of volatile compounds component of between 50,000 and 3,000,000. In certain embodiments, the refined protein has a volatile compounds component of less than 2,500,000.

In certain embodiments, the refined protein has an isoflavones component of between 0% and 0.1% of dry mass. In certain embodiments, the refined protein has an isoflavones component of less than 0.075% of dry mass.

In certain embodiments, the refined protein has a tannins component of between 0% and 0.5% of dry mass. In certain embodiments, the refined protein has a tannins component of less than 0.3% of dry mass.

In certain embodiments, the refined protein has an instability index of between 0.2 and 0.6. In certain embodiments, the refined protein has an instability index of at least 0.22. In certain embodiments, the refined protein has an instability index of less than 0.57.

In certain embodiments, the refined protein has been produced in quantities of at least between 500-kg and 3000-kg, between 1-kg and 1000-kg, between 1000-kg and −2500-kg and between 1000-kg and 3500-kg.

Methods for Obtaining Refined Protein Components

Certain embodiments are directed to methods for obtaining refined protein components from non-animal natural sources. Some of the advantages of the methods provided herein are that they may remove, or substantially remove, flavoring agents, aroma agents, coloring agents, other agents or combinations thereof from refined protein preparations, and thus make the refined protein preparations more suitable for use in non-dairy analog. Removal of such agents may also increase the shelf life of non-dairy analogs comprising such refined protein components.

The methods provided herein for obtaining refined protein components from non-animal natural sources may comprise one or more of the following steps, in or out of order:

a. obtaining a protein preparation from a non-animal natural source;

b. washing the protein preparation at a wash pH;

c. extracting the protein preparation at an extraction pH to obtain an aqueous protein solution;

d. separating the aqueous protein solution from non-aqueous components;

e. adding salt;

f. precipitating the protein from the aqueous protein solution at a precipitation pH to obtain a protein precipitate;

g. separating the protein precipitate from non-precipitated components; and

h. washing the protein precipitate to obtain a refined protein component.

The refined protein preparation obtained from a natural source may have various forms, including, but not limited to, protein concentrate, protein isolate, flour, protein meal; native, denatured, or renatured protein; dried, spray dried, or not dried protein; enzymatically treated or untreated protein; and combinations thereof. It may consist of particles of one or more sizes, and may be pure or mixed with other components (e.g., other plant source components). The refined protein preparation may be derived from non-animal natural sources, or from multiple natural sources. In some embodiments, the refined protein preparation is obtained from a plant. In some such embodiments, the plant is legume. In some such embodiments, the legume is pea. The pea may be whole pea or a component of pea, standard pea (i.e., non-genetically modified pea), commoditized pea, genetically modified pea, or combinations thereof. In some embodiments, the pea is Pisum sativum. In some embodiments, the legume is soy. The soy may be whole soy or a component of soy, standard soy (i.e., non-genetically modified soy), commoditized soy, genetically modified soy, or combinations thereof. In some embodiments, the legume is chickpea. The chickpea may be whole chickpea or a component of chickpea, standard chickpea (i.e., non-genetically modified chickpea), commoditized chickpea, genetically modified chickpea, or combinations thereof. In some embodiments, the refined protein preparation may be pre-treated for various purposes, such as, for example, extracting the protein preparation in a solvent to remove lipids, and heat treating the protein preparation to remove volatiles.

Washing the refined protein preparation may utilize various methods, including single wash, multiple washes, and/or counter-current washes.

The wash and extraction pH may be a pH that is suitable for washing and solubilizing proteins in a protein preparation. A suitable wash and extraction pH may be determined by testing various pH conditions, and identifying the pH condition at which the most optimal yield and quality (judged by, for example by one or more of the following: flavor, odor, color, nitrogen content, Ca content, heavy metal content, emulsification activity, MW distribution, and thermal properties of the protein component obtained) of the refined protein component is obtained. In some embodiments, the wash and extraction pH are alkaline pH. In some such embodiments, the alkaline pH is at least 7.1, at least 8, at least 9, at least 10, at least 11, at least 12, between 7.1 and 10, between 8 and 10, between 9 and 10, or between 8 and 9. In some such embodiments, the alkaline pH is 8.5. In some embodiments, the wash and extraction pH are acidic pH. In some such embodiments, the acidic pH is less than 7, less than 6.95, less than 6.5, less than 5, less than 4, less than 3, between 2 and 6.95, between 3 and 6, or between 3 and 5. The extraction pH may be adjusted using a pH adjusting agent. In some embodiments, the pH adjusting agent is a food grade basic pH adjusting agent. In other embodiments, the pH adjusting agent is a food grade acidic pH adjusting agents. Examples of suitable acidic pH adjusting agents include, but are not limited to, phosphoric acid, acetic acid, hydrochloric acid, citric acid, succinic acid, and combinations thereof. Examples of suitable basic pH adjusting agents include, but are not limited to, potassium bicarbonate, sodium bicarbonate, sodium hydroxide, potassium hydroxide, calcium hydroxide, ethanolamine, calcium bicarbonate, calcium hydroxide, ferrous hydroxide, lime, calcium carbonate, trisodium phosphate, and combinations thereof. It is useful to obtain substantially as much extracted protein as is practicable so as to provide an overall high product yield. The yield of protein in the aqueous protein solution may vary widely, wherein typical yields range from 1% to 90%. The aqueous protein solution typically has a protein concentration of between 1 g/L and 300 g/L. The molecular weight distribution of the proteins comprised in the aqueous protein solution may vary widely.

Separating the aqueous protein solution from non-aqueous components may be accomplished by various methods, including but not limited to, centrifugation followed by decanting of the supernatant above the pellet, or centrifugation in a decanter centrifuge. The centrifugation may be followed by disc centrifugation and/or filtration (e.g., using activated carbon) to remove residual protein source material and/or other impurities. The separation step may be conducted at various temperatures within the range of 1° C. to 100° C. For example, the separation step may be conducted between 10° C. and 80° C., between 15° C. and 70° C., between 20° C. and 60° C., or between 25° C. and 45° C. The non-aqueous components may be re-extracted with fresh solute at the extraction pH, and the protein obtained upon clarification combined with the initial protein solution for further processing as described herein. The separated aqueous protein solution may be diluted or concentrated prior to further processing. Dilution is usually affected using water, although other diluents may be used. Concentration may be affected by membrane-based methods. In some embodiments, the diluted or concentrated aqueous protein solution comprises between 1 g/L and 300 g/L, between 5 g/L and 250 g/L, between 10 g/L and 200 g/L, between 15 g/L and 150 g/L, between 20 g/L and 100 g/L, or between 30 g/L and 70 g/L by weight of protein.

The protein in the aqueous protein solution may be optionally concentrated and/or separated from small, soluble molecules. Suitable methods for concentrating include, but are not limited to, diafiltration or hydrocyclonation. Suitable methods for separation from small, soluble molecules include, but are not limited to, diafiltration.

Salt precipitation may be accomplished using various suitable salts and precipitation pHs. Suitable salts, salt concentrations, polysaccharides, polysaccharide concentrations, and precipitation pHs may be determined by testing various conditions, and identifying the salt and pH and polysaccharide condition which are obtained the most colorless and/or flavorless protein precipitates at the most optimal yield and quality (judged by, for example, by one or more of the following: flavor, odor, color, nitrogen content, Ca content, heavy metal content, emulsification activity, MW distribution, and thermal properties of the protein component obtained). In some embodiments, salt precipitation occurs with calcium dichloride at a concentration of between 5 mM and 1,000 mM. Other examples of suitable salts include, but are not limited to, other alkaline earth metal or divalent salts (e.g., magnesium chloride, sodium chloride, calcium permanganate, and calcium nitrate). Typically, the precipitation pH is opposite the extraction pH (i.e., when the extraction pH is in the basic range, the precipitation pH is most suitable in the acidic range, and vice versa). In some embodiments, the precipitation pH is an acidic pH. In some such embodiments, the acidic pH is less than 7.1, less than 6, less than 5, less than 4, less than 3, less than 2, between 6.9 and 2, between 6 and 3, between 6 and 5, or between 5 and 4. In some such embodiments, the acidic pH is 5.25. The precipitation pH may be adjusted using a pH adjusting agent. In some embodiments, the pH adjusting agent is a food grade acidic pH adjusting agent. In other embodiments, the pH adjusting agent is a food grade basic pH adjusting agent.

Separating the protein precipitate from non-precipitated components may occur by one or more of the methods disclosed herein.

Washing of the protein precipitate may occur by various methods. In some embodiments, the washing is carried out at the precipitation pH.

The protein precipitate may optionally be suspended. In some embodiments, the suspending is carried out at the extraction pH, for example, in the presence of a chelator to remove calcium ions. If the suspended protein preparation is not transparent it may be clarified by various convenient procedures such as filtration or centrifugation.

The pH of the suspended color-neutral refined protein component may be adjusted to a pH of between 1 and 14, between 2 and 12, between 4 and 10, or between 5 and 7, by the addition of a food grade basic pH adjusting agent, including, for example, sodium hydroxide, or food grade acidic pH adjusting agent, including, for example, hydrochloric acid or phosphoric acid.

The pH of the refined protein component and/or refined protein isolate may be adjusted to a pH of between 1 and 14, between 2 and 12, between 4 and 10, or between 5 and 7, by the addition of a food grade basic pH adjusting agent, including, for example, sodium hydroxide, or food grade acidic pH adjusting agent, including, for example, hydrochloric acid or phosphoric acid.

The refined protein component may be dried. Drying may be performed in a suitable way, including, but not limited to, spray drying, dry mixing, agglomerating, freeze drying, microwave drying, drying with ethanol, evaporation, refractory window dehydration or combinations thereof.

The refined protein component and/or refined protein isolate may be dried. Drying may be performed in a suitable way, including, but not limited to, spray drying, dry mixing, agglomerating, freeze drying, microwave drying, drying with ethanol, evaporation, refractory window dehydration or combinations thereof.

Other optional steps in the methods provided herein are heating steps aimed at removing heat-labile contaminants and/or microbial contaminations, and additional filtering (e.g., carbon filtering) steps aimed at removing additional odor, flavor, and/or color compounds. In some embodiments, such additional filtering is carried out immediately after extracting the protein preparation or after separating the aqueous protein solution from the non-aqueous components.

In some embodiments, the methods provided herein provide a yield of protein of at least 30%, at least 40%, at least 50%, at least 60%, at least 70%, at least 80%, at least 90%, between 30% and 90%%, between 40% and 90%, between 50% and 90%, or between 60% and 90% by weight.

### EXAMPLES

Various features and embodiments of the disclosure are illustrated in the following representative examples, which are intended to be illustrative, and not limiting. Those skilled in the art will readily appreciate that the specific examples are only illustrative of the invention as described more fully in the claims which follow thereafter. Every embodiment and feature described in the application should be understood to be interchangeable and combinable with every embodiment contained within.

### Example 1: Preparation of a Succinylated Refined Protein from Pea Flour

This example illustrates a method for preparing a succinylated refined protein useful in the compositions, formulations and methods of the present disclosure.

Materials and methods: Pea Flour (Ingredion, Westchester, Ill.) was added to distilled water adjusted to pH 8.5 using 6N sodium hydroxide while stirring for approximately 30 to 60 min to a final solids concentration of 20 wt/wt %. The pea flour extract was separated by centrifuging at between 5,000 to 15,000 g for approximately 10 minutes. The supernatant was retained as the extract whereas the pellet was discarded. The supernatant was centrifuged again to clear (or substantially clear) it from solids. Succinic anhydride (0.5 g succinic anhydride/g protein) was slowly added to the supernatant while stirring. Throughout the addition 6N sodium hydroxide was added to maintain pH of the mixture around 8-9. The succinylation reaction with the protein was complete after all of the succinic anhydride was added and the pH stabilized at pH 8-9. The resulting succinylated pea protein was then precipitated from the solution by adding 500 mM CaCl₂) to a final concentration of approximately 50 mM, and adjusting to pH 3 using 6N hydrochloric acid while mixing briefly. The succinylated protein formed as a white precipitate that was separated by centrifuging at between 5,000 to 15,000 g for approximately 10 minutes. The supernatant was discarded, and the precipitate/pellet/paste was washed twice with water adjusted to pH 3 using 6N hydrochloric acid. For each wash water was added to pellet for a final dilution of 25-50×(˜1-2 mL solid pellet mixed in 50 mL water; briefly mix up; acidified with 6N hydrochloric acid; centrifuge as above, repeat).

### Example 2: Isoelectric Point and Increased Solubility Profile of a Succinylated Refined Protein from Pea Flour

This example illustrates the characterization of the effect of succinylation on the isoelectric point and protein solubility profile of refined pea protein.

Materials and methods: Unmodified refined pea protein paste (control) was prepared as in Example 1 but without any addition of succinic anhydride and with the precipitation pH adjusted to pH 5.5. Succinylated refined protein paste was prepared as in Example 1. Both control and succinylated protein pastes were dissolved at 10 wt % in separate water solutions of ˜150 mL. Aliquots (5 mL) of each solution were removed and checked for total protein content using protein combustion analysis on a Leco CN828 (Leco Corporation, St. Joseph, Mich., USA). Titration of each solution was carried out with 1N hydrochloric acid and 1N sodium hydroxide. Aliquots (5 mL) of each solution at different pH points were removed, then twice spun down (3500 rpm/5 min and 10,000 rpm/5 min), and supernatant of each was checked to determine soluble protein content. The soluble protein % was calculated by dividing the soluble protein by the total protein content.

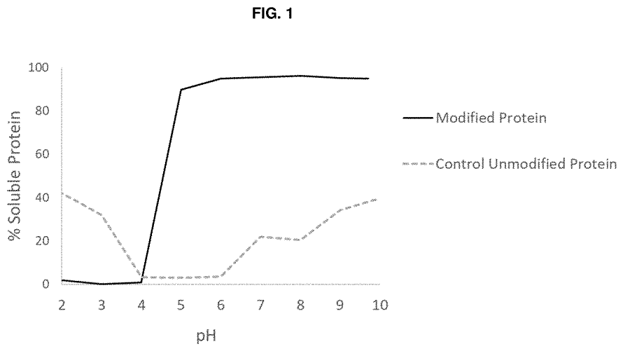

Results: As shown in FIG. 1, the solubility of the succinylated refined pea protein increased substantially relative to the unmodified refined pea protein starting at around pH 4 as compared. Additionally, the solubility plot of FIG. 1 shows succinylated refined pea protein had a decreased isoelectric point relative to the unmodified refined pea protein.

### Example 3: Comparing Feathering in Coffee of Non-Dairy Analogs Made Using Unmodified or Succinylated Refined Pea Protein

This example illustrates experiments to measure and compare the feathering characteristics in coffee of a non-dairy analog made using a succinylated refined pea protein relative to a non-dairy analog made using an unmodified refined pea protein (control).

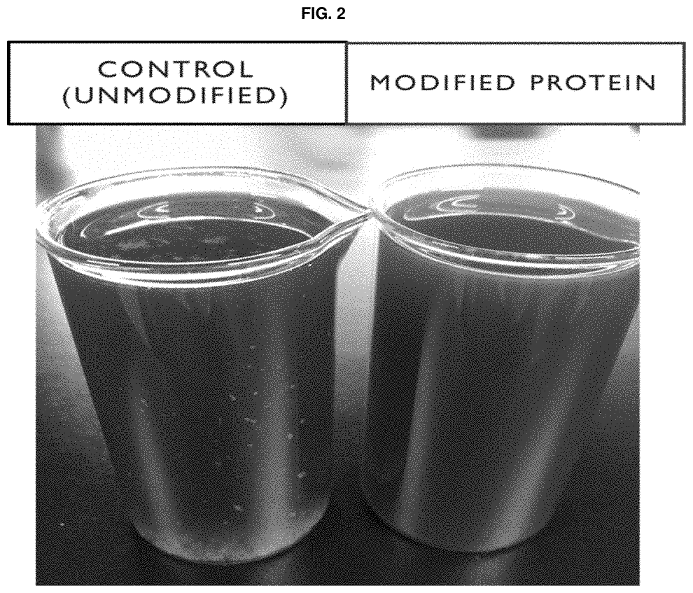

Materials and methods: Succinylated refined pea protein was prepared as provided in Example 1 (50 wt % of succinic anhydride to protein). Unmodified refined pea protein paste (control) was prepared as in Example 1 but without any addition of succinic anhydride and with the precipitation pH adjusted to pH 5.5. Unsweetened non-dairy analogs were formulated and prepared as described in Example 5 using either 100% unmodified refined pea protein, or a 50% unmodified to 50% succinylated refined pea protein. Both non-dairy analog compositions had a protein content of about 3.3% by weight. Coffee was heated to a temperature of between 65-70° C. prior to mixing with the non-dairy analog. The non-dairy analog was maintained at a temperature of between 2-8° C. 200 mL of coffee (pH approximately 5.1) was poured into a beaker and non-dairy beverage (4.75 g, 0.3 Tablespoons) was added. After addition of the non-dairy analog, the coffee solutions were stirred clockwise 5 times and an additional 5 times counterclockwise. Images were taken of the two solutions after 5 minutes and are shown in FIG. 2.

Results: Instant feathering occurred upon addition of the control non-dairy analog (i.e., containing unmodified refined pea protein) into the coffee. As shown in FIG. 2, coagulated solids settled to the bottom of the coffee within 5 minutes after addition. Unlike the control non-dairy analog, the modified non-dairy analog (i.e., containing succinylated refined pea protein) did not feather initially or 5 minutes after addition to the coffee.

### Example 4: Evaluating Ranges of Succinylated Refined Protein Useful in Non-Dairy Analog Formulations to Decrease Feathering

This example illustrates experimental studies used to determine the range of succinylated refined protein relative to unmodified refined protein useful to provide improved feathering quality in a non-dairy analog. Briefly, non-dairy analogs were prepared with an increasing percentage of succinylated refined protein relative to the overall amount of refined protein. Each non-dairy analog was added to coffee and the impact of increasing succinylation on feathering within coffee was evaluated.

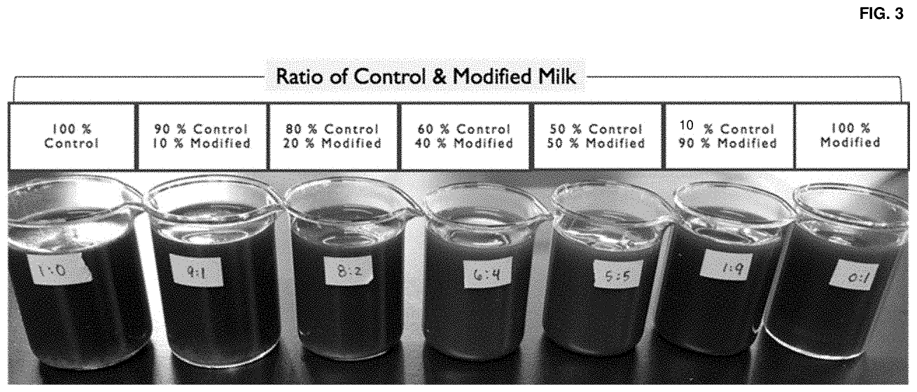

Materials and methods: Succinylated refined pea protein used was prepared as provided in Example 1 (50 wt % succinic anhydride to protein). Unmodified refined pea protein paste (control) was prepared as in Example 1 but without any addition of succinic anhydride and with the precipitation pH adjusted to pH 5.5. Unsweetened non-dairy analogs were formulated and prepared as described in Example 5 using either the unmodified refined pea protein or the succinylated refined pea protein with a protein content of about 3.3% by weight. The non-dairy analogs were mixed in seven different ratios from before proceeding with coffee stability analysis: 100% control to 0% modified (succinylated); 90% control to 10% modified (succinylated); 80% control to 20% modified (succinylated); 60% control to 40% modified (succinylated); 50% control to 50% modified (succinylated); 10% control to 90% modified (succinylated); and 0% control to 100% modified (succinylated). Coffee was heated to between 65-70° C. prior to mixing with the mixture ratios of non-dairy analogs. The non-dairy analog was between 2-8° C. Coffee (90 mL) was poured into a beaker and initial pH checked to be about 5.1. Each non-dairy analog (2.15 g, 0.14 Tablespoons) was added to the coffee followed by stirring clockwise 5 times and an additional 5 times counterclockwise. Photographic images were taken of the coffee solutions after 5 min as shown in FIG. 3.

Results: As shown in FIG. 3, feathering was decreased by mixing the succinylated non-dairy analog with control non-succinylated non-dairy analog at a ratio of greater than or equal to 40% of succinylated to control. Additionally, the non-dairy analogs containing 40% and 50% of succinylated refined pea protein appeared to have a creamier and whiter look without feathering.

### Example 5: Preparation of a Non-Dairy Analog

This example illustrates compositions and methods for preparing non-dairy analog products using a succinylated refined protein component of the present disclosure.

An exemplary non-dairy analog can be formulated and prepared based on the composition of ingredients shown in Table 1.

TABLE 1
Composition of Non-Dairy Analog

| Ingredient | Supplier | % by weight |
|---|---|---|
| Water, filtered | | 83-94 |
| Refined protein component(s) | Succinylated and/or unmodified | 2-5 |
| (including any ratio of unmodified to | refined pea proteins e.g., as | |
| succinylated pea protein, e.g., 100:0, | prepared in Example 1 | |
| 90:10, 50:50, 10:90, 0:100.) | | |
| Organic Expeller Pressed Sunflower Oil | Spectrum (Boulder, CO) | 1-10 |
| Phosphate salts | ICL (Tel Aviv, Israel) | 0.3-1 |
| Flavoring agents (e.g., natural milk type | | 0-1 |
| flavor and natural butter type flavor) | | |
| Potassium Hydroxide, 45% | | 0.02-1.00 |
| Purified Sea Salt, Untreated | Cargill | 0-0.15 |
| Giralec Sunflower Lecithin non-GMO | Austrade (Palm Beach Gardens, FL) | 0.05-0.15 |
| Guar Gum, inorganic | TIC (White Marsh, MD) | 0.01-0.05 |
| Kelcogel HA-B Gellan | CP Kelco (Atlanta, GA) | 0.01-0.05 |

Materials and methods: Dipotassium phosphate, dry flavor, vitamin blend, and gums are combined in a dry blend. Oil is combined with lecithin to obtain an oil blend. The refined protein component is added to the water with mixing for approximately 3 minutes at ˜2,000 rpm to obtain a liquid blend. Phosphate salts are added to the liquid blend, and it is allowed to mix for another minute. The dry blend, oil blend, and liquid flavoring agents are mixed into the liquid blend for approximately 5 minutes at ˜2,400 rpm. 45% Potassium hydroxide is added to adjust the pH to 7.8 (+/−0.05 at 5° C.). The blend is subjected to microthermics with in line homogenization (direct, 145° C., 6 seconds, 2,500 psi). The resulting non-dairy analog product is collected and cooled.

Table 1 provides a range of values for the composition of the ingredients that can be used in preparing a non-dairy analog of the present disclosure. For example, it is contemplated that variations to the amount of unmodified refined protein component used and the amount of succinylated refined protein used. For example, certain exemplary embodiments may use between 0-50% by weight of unmodified refined protein with between 100-50% by weight of the succinylated refined protein. In addition, variations in the formulation of the non-dairy analog of the present example are also contemplated as illustrated in Table 1. For example, different flavoring agents (e.g., natural sweetness enhancer flavor and natural chocolate type flavor, or natural vanilla flavor and vanilla extract) may be used to produce flavored non-dairy analogs (e.g., chocolate non-dairy analog or vanilla non-dairy-analog, respectively). Additionally, different phosphate salts (e.g., potassium phosphate, dipotassium phosphate, sodium phosphate, tricalcium phosphate, and disodium phosphate) may be used to produce certain non-dairy analogs (e.g., milk, barista style milk, and creamer).

### Example 6: Effects of pH and Succinylating Reagent Concentration on Solubility of Succinylated Pea Protein Extract

This example illustrates experimental studies used to determine effects of pH and succinylating reagent concentration on preparation of a succinylated pea protein with improved solubility properties for use in non-dairy analogs. Briefly, pea protein was treated with the succinylating reagent, succinic anhydride (“SA”) under three different pH conditions (all with 20 wt % SA used) and six different weight percentages of SA to protein ranging from 5 wt % to 50 wt %.

Materials and methods: Succinylation was carried out on pea protein extracted from pea protein concentrate. A range of ratios of succinic anhydride reagent to protein concentrate was used to identify a minimum amount of succinylation sufficient to lower the isoelectric point of the modified proteins and increase their overall solubility. The ratios used were 0.05, 0.075, 0.1, 0.2, 0.35, and 0.5 g anhydride per g protein. Succinic anhydride was added to the protein extract slowly while stirring. Throughout the SA reagent addition, 6N sodium hydroxide was added so as to maintain a pH of 8-10. The succinylation reaction was complete after all the succinic anhydride was added and the pH had stabilized at 8-10. The protein was precipitated from the reaction mixture using 6N phosphoric acid to decrease the pH down to 3. Precipitation was also carried out of an unmodified (control) protein extracts using 6N phosphoric acid to decrease the pH to 5.5.

Titration of the precipitated succinylated and unmodified (control) protein pastes (5 wt % in separate water solutions of ˜150 mL) was carried out using 1N sodium hydroxide. Aliquots (5 mL) of each solution were removed during titration and total protein content was measured by protein combustion analyzer. All aliquots were then spun down (3500 rpm/5 min), and soluble protein content in each supernatant was measured by protein combustion analyzer. The soluble protein % was calculated by dividing the soluble protein by the total protein content.

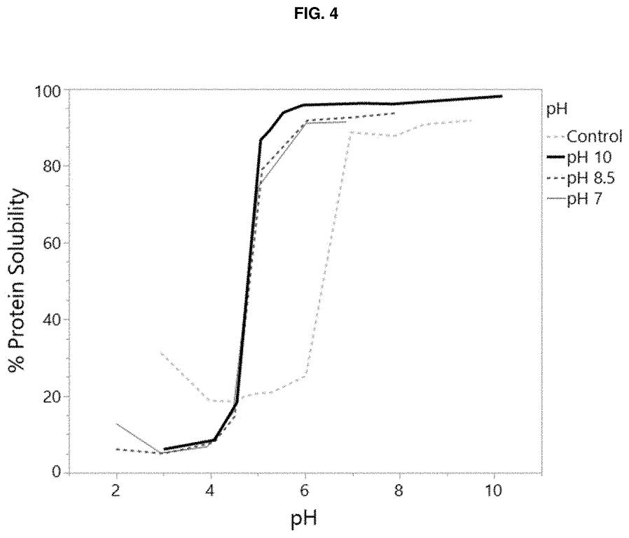

Results: As shown by the plot depicted in FIG. 4, modification of the pea protein with SA shifts the solubility curves substantially to lower pH (e.g., from about pH 6.5 for modified to about pH 5 for succinylated). The degree of this pH shift did not change significantly between the three different pH conditions used for the succinylation reactions. The succinylated protein generated at pH 10, however, exhibited a higher solubility in the alkaline range (pH 8 to pH 10) relative to the succinylated proteins generated in the reaction at pH 7 or pH 8.5. Accordingly, the further studies involving various weight percentages were carried out at pH 10.

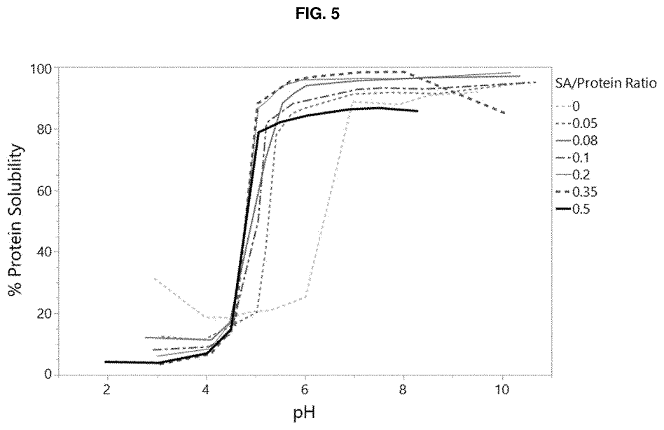

As shown by the plot depicted in FIG. 5, the modification of the pea protein (at pH 10) with differing weight percentages of SA to protein, including 5 wt %, 7.5 wt %, 10 wt %, 20 wt %, 35 wt %, and 50 wt %, all resulted in a substantial shift in solubility to lower pH relative to the control unmodified protein. The increase in succinic anhydride to 50 wt %, however, has a negative effect on solubility. This negative effect at 50 wt % also was observed in reactions carried out at pH 7 and 8.5 (data not shown). The pH shift was noticeably less for the proteins succinylated with only 5 wt %, but the pH shift and improved solubility due to succinylated protein was comparable over the range from 10 wt % to 35 wt %. Accordingly, further studies involving succinylated pea protein were carried out using only 10 wt % succinic anhydride to prepare the succinylated protein.

### Example 7: Effects of Succinylation on Precipitation of Refined Pea Protein

This example illustrates experimental studies used to determine the effects of using succinylated pea protein (relative to unmodified pea protein) during preparation of refined protein component by precipitation. Briefly, succinylated pea protein extract, prepared as described in Example 6, was precipitated at pH 3 and 60° C. to prepare a succinylated refined protein, generally as described in Example 2. This succinylated refined pea protein was tested for solubility relative to unmodified control refined pea protein.

Materials and methods: Similar to Example 6, pea protein succinylation was carried out on pea protein extracted from pea protein concentrate using a ratio of 10 wt % SA to protein at pH 10. Protein was precipitated using phosphoric acid to adjust the pH down to 5.5 and 3 for unmodified and succinylated protein extracts respectively. Titration of unmodified (control) and succinylated protein pastes was performed as described in Example 6.

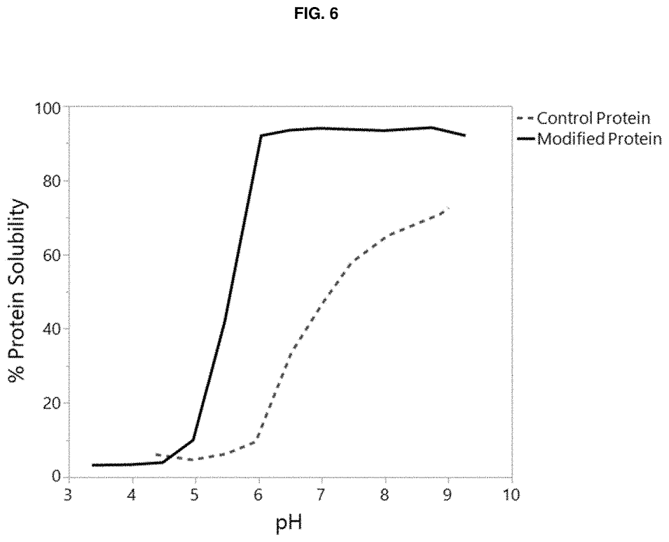

Results: As shown by the plot depicted in FIG. 6, the solubility titration curve for the succinylated refined pea protein prepared by precipitation at pH 3, is significantly shifted to lower pH and exhibit significantly higher peak solubility relative to the un-modified control refined pea protein prepared by precipitation at pH 5.5. The solubility at pH 7 and above is as high as 90% whereas the solubility of the control only reaches 60% maximum.

Additionally, the yield of the succinylated refined pea protein from the precipitation process was about 5% higher. Specifically, the precipitation yield of the succinylated protein was 91.7% (versus 85.5% for the control) and the total yield was 70.4% (versus 65.9% for the control). Succinylation did not significantly affect the color of the precipitated refined pea protein product, as shown by the very similar CIELAB color space values for control and succinylated protein, which are L=75.16, a=4.73, b=20.70, and L=75.69, a=4.57, b=17.88 respectively.

### Example 8: Preparation of Succinylated Refined Protein from a Spray-Dried Unmodified Protein Isolate

This example illustrates an alternative preparation of a succinylated refined pea protein in which the succinylation reaction is carried out “post-purification” using a spray-dried isolate of pea protein. Briefly, a spray-dried protein isolate is prepared at manufacturing scale, reconstituted at pH 7, 8, or 9, and then treated with succinic anhydride at these three pHs. The solubility of the three succinylated protein solutions prepared by this method was determined relative to the unmodified protein.

Materials and Methods: spray-dried protein isolate was prepared at manufacturing scale using a process similar to that described in Example 1, except without the succinic anhydride addition. The precipitated protein isolate was reconstituted with deionized water to create a 5% protein solution which was then separated into four aliquots of 200 mL and adjusted to pH 7, 8, 9, or 10 with 6N sodium hydroxide. The solutions at pH 7, 8, and 9 were treated with 10 wt % succinic anhydride and mixed for 5 minutes. The solution at pH 10 was not treated and used as the unmodified control sample. The solubility of the succinylated proteins prepared by this method was determined relative to the unmodified protein by titration as described in Example 6.

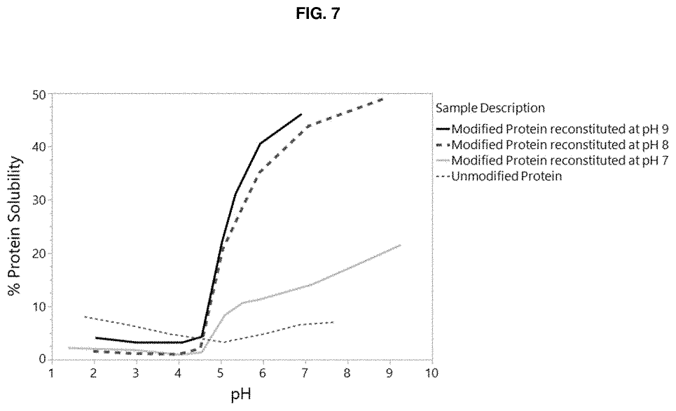

Results: As shown by the solubility plots depicted in FIG. 7, the solubility of the succinylated refined pea protein prepared from a spray-dried pea protein isolate by succinylation reaction carried out at pH 8 and pH 9 exhibited greatly increased solubility at pH 6 and above relative to the unmodified refined protein. The succinylated refined pea protein prepared by succinylation reaction carried out at pH 7, however, showed significantly lower solubility.

### Example 9: Solubility and Foaming Properties of Spray-Dried Succinylated Refined Pea Protein Prepared at Pilot Scale

This example illustrates experimental studies that spray-dried succinylated refined pea protein prepared at pilot scale (˜120 kg batch) exhibits improved solubility at acidic pH 6 and improved foaming relative to the unmodified refined pea protein.

Materials and materials: Extraction batches of 120 kg were prepared in a tank by mixing 108 kg of hot tap water and 12 kg of pea protein concentrate (PulsePlus Pea Protein 55, AGT Foods, SK, Canada). The water was heated through a heat exchanger, targeting a batch temperature of 55-65° C. 6N sodium hydroxide solution was added to the slurry while mixing to pH 9. To produce modified protein, succinic anhydride salt was added in a ratio to protein of 10 wt % and agitated for 45 min. To produce unmodified protein (control) the succinic anhydride addition was omitted. This slurry was fed into an Alfa Laval Foodec decanter to separate the soluble protein from the insoluble ingredients (which are predominantly starch and fiber). The decanted soluble protein solution was collected in a drum, heated to 60° C. through a heat exchanger, and then fed continuously through a pipe with continuous addition of 75% phosphoric acid solution. The resulting coagulated protein slurry was collected in a tank and then washed with 20-60° C. water 3.5:1. This protein slurry was fed to an Alfa Laval Clara 20 disc stack and the solid discharge collected as the final wet purified protein product. This wet product was pasteurized and spray-dried to a powder. Solubility of the modified and control protein isolates was measured as described in Example 6.

The foaming production of the modified and unmodified (control) powder was evaluated as follows. 75 mL of 3% protein in water solution was prepared, adjusted to pH 6.5, and mixed for 1 min in an electric milk frother (Epica, Brick, N.J., USA). The foamed solution was poured into a graduated cylinder and the volumes were noted. Foam expansion % was calculated as volume after foaming over initial volume of the sample.

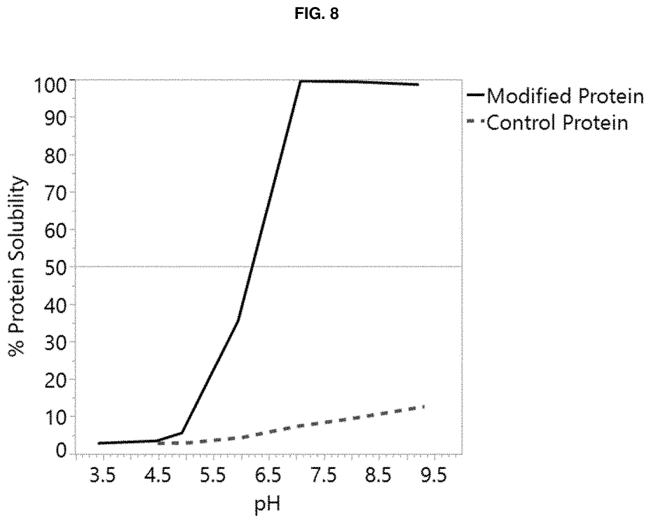

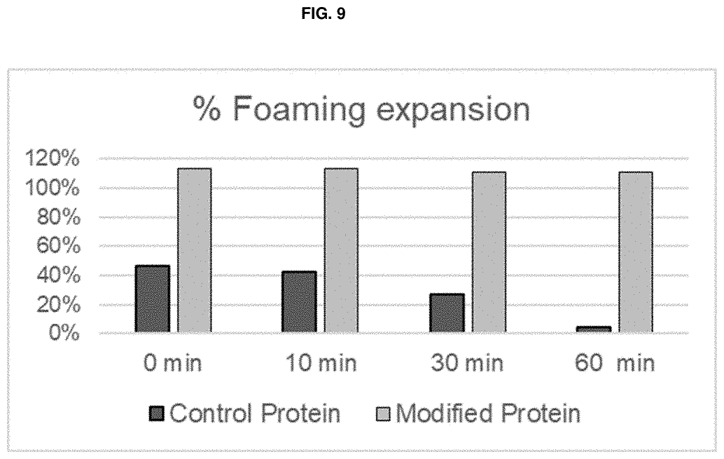

Results: As shown in the plots of FIG. 8, the succinylated refined pea protein prepared from the spray-dried pea protein isolate exhibited 50% solubility at pH 6, whereas the control unmodified pea protein isolate prepared similarly exhibited less than 5% solubility at pH 6. Additionally, the succinylated refined pea protein was observed to produce a dense and stable foam compared to the control unmodified pea protein. This improved foaming quality was further shown by the results depicted in FIG. 9. The succinylated refined pea protein exhibited over 100% foaming expansion even at 60 min, wherein the control unmodified refined pea protein exhibited only 40% foaming expansion at 0 min that decreased to approximately 5% at 60 min.

### Example 10: Comparing Feathering in Coffee of Non-Dairy Analogs Made Using Unmodified or Succinylated Refined Pea Protein Prepared at Pilot Scale

This example illustrates experimental studies demonstrating the improved feather of non-dairy analogs containing succinylated refined pea protein that was prepared at pilot scale (˜120 kg batch) and spray-dried. Briefly, unmodified (control) refined pea protein and succinylated refined pea protein a non-dairy analog were prepared as in Example 9. Non-dairy analogs were prepared from these modified and succinylated refined pea protein isolates as described below. The feathering of each non-dairy analog in coffee was then determined.

Materials and methods: Phosphate salts and gums are combined in a dry blend. Oil is combined with lecithin to obtain an oil blend. The refined protein component(s) and liquid flavors are added to the water and mixed for approximately 3 minutes at ˜8,000 rpm to obtain a liquid blend. The dry blend is added to the liquid blend, and it is allowed to mix for another minute. The oil blend is mixed into the liquid blend for approximately 1 minute at 8,000 rpm. Potassium hydroxide is added to adjust the pH to 7.8 (+/−0.05 at 5° C.). The blend is subjected to homogenization (2,500 psi) and direct steam injection thermal process (140° C., 4 seconds). The resulting non-dairy analog product is collected and cooled.

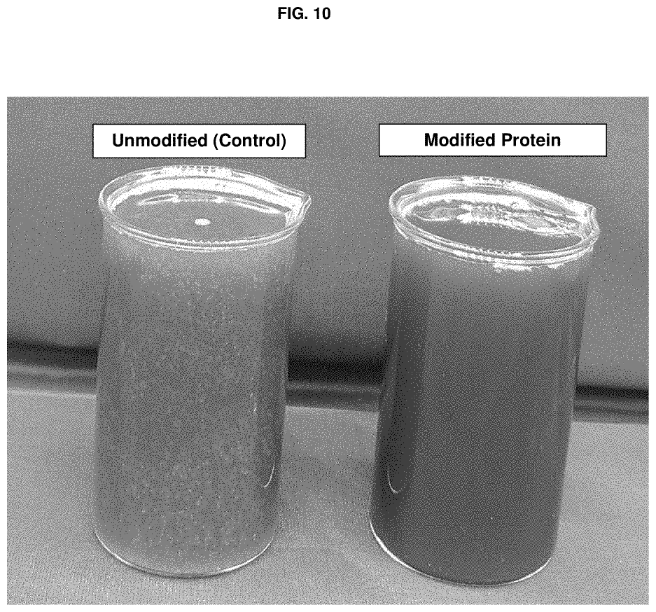

Feathering characteristics of the control (unmodified) and succinylated protein non-dairy analogs were determined in coffee as follows. Two unsweetened non-dairy analogs were prepared as described in Example using either 100% unmodified pea protein, or 100% succinylated pea protein. The non-dairy analogs were maintained at a temperature of between 2-8° C. Coffee was heated to 65-70° C. prior to mixing with each of the non-dairy analogs. 200 mL of coffee (pH 5.4) was poured into a beaker and the non-dairy analog (4.75 g, 0.3 TBS) was added. Solutions were stirred clockwise 5 times and an additional 5 times counterclockwise. Images taken of solutions after 5 min and are shown in FIG. 10.

Results: As shown in FIG. 10, instant feathering was observed for the unmodified (control) non-dairy analog mixed in coffee, and the feathering solids settled to the bottom of the coffee within 5 min after addition. In contrast, the succinylated (modified) protein non-dairy analog did not exhibit feathering initially, or even 5 min after addition to the coffee. To further quantify the difference in feathering, 10 mL aliquots of each of the non-dairy analog/coffee mixtures were centrifuged for 5 min at 50 g. The measured volumes of resulting solid pellets were 0.3 mL for the unmodified (control) non-dairy analog, and <0.1 mL for the succinylated protein non-dairy analog.

Notwithstanding the appended claims, the disclosure set forth herein is also defined by the following clauses, which may be beneficial alone or in combination, with one or more other causes or embodiments. Without limiting the foregoing description, certain non-limiting clauses of the disclosure numbered as below are provided, wherein each of the individually numbered clauses may be used or combined with any of the preceding or following clauses. Thus, this is intended to provide support for all such combinations and is not necessarily limited to specific combinations explicitly provided below:

A1. A non-dairy analog, the non-dairy analog comprising: (a) a refined protein component in which at least a portion of the refined protein component is a succinylated refined protein component; (b) at least one lipid in which the at least one lipid is from a non-animal natural source; (c) at least one emulsifier; (c) water; and (d) a pH of between 4.0 and 10; optionally, a pH of between 6.5 and 10.

A2. A non-dairy analog, the non-dairy analog comprising: (a) at least 1% by weight of a refined protein component in which at least 30% by weight of the refined protein component is a succinylated refined protein component; (b) between 1% by weight and 10% by weight of at least one lipid in which the at least one lipid is from a non-animal natural source; (c) between 0.01% by weight and 10% by weight of at least one emulsifier; (d) water; and (e) a pH of between 4.0 and 10; optionally, a pH of between 6.5 and 10.

A3. The non-dairy analog of clauses A1 or A2, wherein at least 90% by weight of the non-dairy analog is capable of being solubilized in an aqueous composition, wherein the aqueous composition has a temperature that is between 30° C. and 95° C. and an aqueous composition pH that is less than 7, before the non-dairy analog is combined with the aqueous composition or after the non-dairy analog is combined with the aqueous composition.

A4. The non-dairy analog of clauses A1 or A2, wherein at least 95% by weight of the non-dairy analog is capable of being solubilized in an aqueous composition, wherein the aqueous composition has a temperature that is between 30° C. and 95° C. and an aqueous composition pH that is less than 7, before the non-dairy analog is combined with the aqueous composition or after the non-dairy analog is combined with the aqueous composition. A5. The non-dairy analog of one or more of clauses A1 to A4, wherein non-dairy analog is capable of being solubilized, or substantially solubilized, in the aqueous composition for at least 5 minutes, 10 minutes, or 15 minutes after at least partial mixing of the non-dairy analog composition with the aqueous composition.

A6. The non-dairy analog of one or more of clauses A1 to A5, wherein at least 90%, or at least 95%, by weight of the non-dairy analog composition capable of being stable in the aqueous composition for at least 5 minutes, 10 minutes, or 15 minutes after at least partial mixing of the non-dairy analog composition with the aqueous composition.

A7. The non-dairy analog of one or more of clauses A1 to A6, wherein the non-dairy analog is capable of not visibly precipitating when added to the aqueous composition for at least 5 minutes, 10 minutes, or 15 minutes after at least partial mixing of the non-dairy analog composition with the aqueous composition.

A8. The non-dairy analog of one or more of clauses A1 to A7, wherein the non-dairy analog is capable of exhibiting insubstantial precipitation when added to the aqueous composition for at least 5 minutes, 10 minutes, or 15 minutes after at least partial mixing of the non-dairy analog composition with the aqueous composition.

A9. The non-dairy analog of one or more of clauses A1 to A8, wherein the non-dairy analog is capable of exhibiting less than 5%, 3%, 1% or 0.5% by weight precipitation when added to the aqueous composition after at least partial mixing of the non-dairy analog with the aqueous composition.

A10. The non-dairy analog of one or more of clauses A1 to A9, wherein the non-dairy analog is capable of not visibly feathering when added to the aqueous composition for at least 5 minutes, 10 minutes, or 15 minutes after at least partial mixing of the non-dairy analog with the aqueous composition.

A11. The non-dairy analog of one or more of clauses A1 to A10, wherein the succinylated refined protein component is at least 30%, 40%, 50%, 60%, 70%, 80%, 90% or 100% by weight of the total weight of the refined protein component.

A12. The non-dairy analog of one or more of clauses A1 to A10, wherein the succinylated refined protein component is between 30% to 100%, 40% to 100%, 40% to 60%, 40% to 70% or 30% to 50% by weight of the total weight of the refined protein component.

A13. The non-dairy analog of one or more of clauses A1 to A12, wherein the succinylated refined protein component is capable of increasing the total solubility of the refined protein component by at least 10%, 20%, 50%, 60% or 70% when the non-dairy analog is combined with the aqueous composition and the aqueous composition pH is between 3 to 10 before the non-dairy analog is combined with the aqueous composition.

A14. The non-dairy analog of one or more of clauses A1 to A12, wherein the succinylated refined protein component is capable of increasing the total solubility of the refined protein component by at least 10%, 20%, 50%, 60% or 70% when the non-dairy analog is combined with the aqueous composition, wherein the aqueous composition pH is less than 7 before the non-dairy analog is combined with the aqueous composition.

A15. The non-dairy analog of one or more of clauses A1 to A12, wherein the succinylated refined protein component is capable of increasing the total solubility of the refined protein component by at least 10%, 20%, 50%, 60% or 70% when the non-dairy analog is combined with the aqueous composition, wherein the aqueous composition pH is between 3 and 6, before the non-dairy analog is combined with the aqueous composition.

A16. The non-dairy analog of one or more of clauses A1 to A12, wherein the succinylated refined protein component is capable of increasing the total solubility of the refined protein component by at least 10%, 20%, 50%, 60% or 70% when the non-dairy analog is combined with the aqueous composition, wherein the aqueous composition has a temperature of between 30° C. and 95° C. and the aqueous composition pH is between 3 and 10, before the non-dairy analog is combined with the aqueous composition.

A17. The non-dairy analog of one or more of clauses A1 to A12, wherein the succinylated refined protein component is capable of increasing the total solubility of the refined protein component by at least 10%, 20%, 50%, 60% or 70% when the non-dairy analog is combined with the aqueous composition, wherein the aqueous composition has a temperature of between 30° C. and 95° C. and the aqueous composition pH is less than 7, before the non-dairy analog is combined with the aqueous composition.

A18. The non-dairy analog of one or more of clauses A1 to A12, wherein the succinylated refined protein component is capable of increasing the total solubility of the refined protein component by at least 10%, 20%, 50%, 60% or 70% when the non-dairy analog is combined with the aqueous composition, wherein the aqueous composition has a temperature of between 30° C. and 95° C. and the aqueous composition pH of between 3 and 6, before the non-dairy analog is combined with the aqueous composition.

A19. The non-dairy analog of one or more of clauses A1 to A18, wherein the refined protein component is sourced from a plant.

A20. The non-dairy analog of one or more of clauses A1 to A18, wherein the refined protein component is sourced from a legume.

A21. The non-dairy analog of one or more of clauses A1 to A18, wherein the refined protein component is sourced from a pea plant or a pea protein.

A22. The non-dairy analog of one or more of clauses A1 to A18, wherein the refined protein component is a refined pea protein component in which at least a portion of the refined pea protein component is the succinylated refined pea protein component.

A23. The non-dairy analog of one or more of clauses A1 to A22, wherein the pH of the non-dairy analog is between 4.0 and 8.3, 4.0 and 7.9, 6.5 and 7.9, 7 and 7.9, or 7.5 and 8.3.

A24. The non-dairy analog of one or more of clauses A1 to A23, wherein the pH of the non-dairy analog is at least 4.0, 6.5, 7.3, 7.4, 7.5, 7.6, 7.7, 7.8, 7.9, 8.0, 8.1, 8.2, or 8.3.

A25. The non-dairy analog of one or more of clauses A1 to A24, wherein non-dairy analog has at least 1%, 2%, 3%, 5%, 8% or 10% by weight of the refined protein component.

A26. The non-dairy analog of one or more of clauses A1 to A24, wherein the refined protein component of the non-dairy analog is between 2% to 5%, 3% to 4%, 1% to 10%, 1% to 5%, 3% to 8%, or 2% to 4% by weight.

A27. The non-dairy analog of one or more of clauses A1 to A26, wherein the non-dairy analog is capable of exhibiting less than 5%, 3%, 1% or 0.5% by volume precipitation when added to the aqueous composition after at least partial mixing of the non-dairy analog with the aqueous composition, and wherein the aqueous composition has a temperature that is between 30° C. and 95° C. and an aqueous composition pH that is less than 7, before the non-dairy analog is combined with the aqueous composition or after the non-dairy analog is combined with the aqueous composition.

A28. The non-dairy analog of one or more of clauses A1 or A27, wherein the non-dairy analog is capable of exhibiting less than 5%, 3%, 1% or 0.5% by volume precipitation when added to the aqueous composition after at least partial mixing of the non-dairy analog with the aqueous composition, and, wherein the aqueous composition has a temperature that is between 30° C. and 95° C. and an aqueous composition pH that is less than 7, before the non-dairy analog is combined with the aqueous composition.

A29. The non-dairy analog of one or more of clauses A1 to A28, wherein the non-dairy analog is capable of exhibiting less than 5%, 3%, 1% or 0.5% by volume precipitation when added to the aqueous composition for at least 5 minutes, 10 minutes, or 15 minutes after at least partial mixing of the non-dairy analog composition with the aqueous composition.

B1. A method of using a non-dairy analog component comprising; 1) combining a non-dairy analog with an aqueous composition where the aqueous composition is between 30° C. and 95° C. and has a pH of less than 7 prior to being combined with the non-dairy analog; and 2) at least partial mixing the non-dairy analog with the aqueous composition in order to at least partial distribute the non-dairy analog with the aqueous composition, wherein the non-dairy analog comprises: (a) a refined protein component in which at least a portion of the refined protein component is a succinylated refined protein component; (b) at least one lipid in which the at least one lipid is from a non-animal natural source; (c) at least one emulsifier; (d) water; and (e) a pH of between 4.0 and 10, optionally a pH between 6.5 and 10; wherein the non-dairy analog is substantially soluble when combined with the aqueous composition.

B2. A method of using a non-dairy analog comprising; 1) combining a non-dairy analog with an aqueous composition where the aqueous composition is between 40° C. and 90° C. and has a pH of less than 7 prior to being combined with the non-dairy analog; and 2) at least partial mixing the non-dairy analog with the aqueous composition in order to at least partially distribute the non-dairy analog with the aqueous composition, wherein the non-dairy analog comprises: (a) at least 10% by weight by weight of a refined protein component in which at least 30% by weight of the refined protein component is a succinylated refined protein component; (b) between 1% by weight and 10% by weight of at least one lipid in which the at least one lipid is from a non-animal natural source; (c) between 0.01% by weight and 10% by weight of at least one emulsifier; (d) water; and (e) a pH of between 4.0 and 10, optionally, a pH between 6.5 and 10; wherein the non-dairy analog is soluble, or substantially soluble, when combined with the aqueous composition.

B3. The method of clause B2, wherein the aqueous composition is a coffee.

B4. The method of clause B2, wherein the aqueous composition is an infusion, for clause tea.

B5. The method of clause B2, wherein the aqueous composition is a hot chocolate.

B6. The method of one or more of clauses B2 to B5, wherein at least 90% by weight of the non-dairy analog is soluble in the aqueous composition after at least partial mixing of the non-dairy analog with the aqueous composition.

B7. The method of one or more of clauses B2 to B5, wherein at least 95% by weight of the non-dairy analog is soluble in the aqueous composition after at least partial mixing of the non-dairy analog with the aqueous composition.

B8. The method of one or more of clauses B2 to B7, wherein non-dairy analog is soluble, or substantially soluble, in the aqueous composition for at least 5 minutes, 10 minutes, or 15 minutes after at least partial mixing of the non-dairy analog with the aqueous composition.

B9. The method of one or more of clauses B2 to B7, wherein at least 90% by weight of the refined protein component in the non-dairy analog is soluble in the aqueous composition.

B10. The method of one or more of clauses B2 to B7, wherein at least 95% by weight of the refined protein component in the non-dairy analog is soluble in the aqueous composition.

B11. The method of clauses B9 or B10, wherein the refined protein component in the non-dairy analog is soluble, or substantially soluble, in the aqueous composition 15 minutes, 10 minutes, or 5 minutes after at least partial mixing of the non-dairy analog with the aqueous composition.

B12. The method of one or more of clauses B2 to B11, wherein the non-dairy analog is stable in the aqueous composition after at least partial mixing of the non-dairy analog with the aqueous composition.

B13. The method of clause B12, wherein at least 90%, or at least 95%, by weight of the non-dairy analog is stable in the aqueous composition after at least partial mixing of the non-dairy analog with the aqueous composition.

B14. The method of clauses B12 or B13, wherein the non-dairy analog is stable in the aqueous composition for at least 5 minutes, 10 minutes, or 15 minutes after at least partial mixing of the non-dairy analog with the aqueous composition.

B15. The method of one or more of clauses B2 to B14, wherein the refined protein component in the non-dairy analog is stable in the aqueous composition after at least partial mixing of the non-dairy analog with the aqueous composition.

B16. The method of clause B15, wherein at least 95%, or at least 95%, by weight of the refined protein component in the non-dairy analog is stable in the aqueous composition after at least partial mixing of the non-dairy analog with the aqueous composition.

B17. The method of clauses B15 or B16, wherein the refined protein component in the non-dairy analog is stable in the aqueous composition for at least 5 minutes, 10 minutes, or 15 minutes after at least partial mixing of the non-dairy analog with the aqueous composition.

B18. The method of one or more of clauses B2 to B17, wherein the non-dairy analog does not visibly precipitate when added to the aqueous composition.

B19. The method of clause B18, wherein the non-dairy analog does not visibly precipitate when added to the aqueous composition for at least 5 minutes, 10 minutes, or 15 minutes after at least partial mixing of the non-dairy analog with the aqueous composition.

B20. The method of one or more of clauses B2 to B19, wherein the refined protein component in the non-dairy analog does not visibly precipitate when added to the aqueous composition.

B21. The method of clause B20, wherein the refined protein component in the non-dairy analog does not visibly precipitate when added to the aqueous composition for at least 5 minutes, 10 minutes, or 15 minutes after at least partial mixing of the non-dairy analog with the aqueous composition.

B22. The method of one or more of clauses B2 to B21, wherein the non-dairy analog exhibits insubstantial precipitation when added to the aqueous composition after at least partial mixing of the non-dairy analog with the aqueous composition.

B23. The method of clause B22, wherein the non-dairy analog exhibits insubstantial precipitation when added to the aqueous composition for at least 5 minutes, 10 minutes, or 15 minutes after at least partial mixing of the non-dairy analog with the aqueous composition.

B24. The method of one or more of clauses B2 to B23, wherein the non-dairy analog exhibits less than 5%, 3%, 1% or 0.5% by weight precipitation when added to the aqueous composition after at least partial mixing of the non-dairy analog with the aqueous composition.

B25. The method of one or more of clauses B2 to B24, wherein the non-dairy analog does not visibly feather when added to the aqueous composition after at least partial mixing of the non-dairy analog with the aqueous composition.

B26. The method of clause B25, wherein the non-dairy analog does not visibly feather when added to the aqueous composition for at least 5 minutes, 10 minutes, or 15 minutes after at least partial mixing of the non-dairy analog with the aqueous composition.

B27. The method of one or more of clauses B2 to B24, wherein the non-dairy analog exhibits insubstantial visibly feathering when added to the aqueous composition after at least partial mixing of the non-dairy analog with the aqueous composition.

B28. The method of clause B27, wherein the non-dairy analog does not visibly feather when added to the aqueous composition for at least 5 minutes, 10 minutes, or 15 minutes after at least partial mixing of the non-dairy analog with the aqueous composition.

B29. The method of one or more of clauses B2 to B24, wherein the non-dairy analog exhibits less than 5%, 3%, 1% or 0.5% by weight feathering when added to the aqueous composition.

B28. The method of clause B29, wherein the non-dairy analog exhibits less than 5%, 3%, 1% or 0.5% by weight feathering when added to the aqueous composition for 15 minutes, 10 minutes, or 5 minutes after at least partial mixing of the non-dairy analog with the aqueous composition.

B29. The method of one or more of clauses B2 to B24, wherein the refined protein component in the non-dairy analog exhibits less than 5%, 3%, 1% or 0.5% by weight feathering when added to the aqueous composition after at least partial mixing of the non-dairy analog with the aqueous composition.

B30. The method of clause B29, wherein the refined protein component in the non-dairy analog non-dairy analog exhibits less than 5%, 3%, 1% or 0.5% by weight feathering when added to the aqueous composition for at least 5 minutes, 10 minutes, or 15 minutes after at least partial mixing of the non-dairy analog with the aqueous composition.

B31. The method of one or more of clauses B1 to B30, wherein the refined protein component is at least 1%, 4%, 4.5%, 5%, 10%, 15% or 20% by weight of the total weight of the non-dairy analog.

B32. The method of one or more of clauses B1 to B30, wherein the refined protein component is between 1% and 20%, 4% and 10%, 4% and 5%, 5% and 15% or 10% and 16% by weight of the total weight of the non-dairy analog.

B33. The method of one or more of clauses B1 to B32, wherein the succinylated refined protein component is at least 20%, 30%, 40%, 50%, 60%, 70%, 80%, 90% or 100% by weight of the total weight of the refined protein component.

B34. The method of one or more of clauses B1 to B32, wherein the succinylated refined protein component is between 40% to 60%, 20% to 70%, 30% to 80%, 35% to 90%, 20% to 60% or 40% to 100% by weight of the total weight of the refined protein component.

B35. The method of one or more of clauses B1 to B32, wherein the succinylated refined protein component increases the total solubility of the refined protein component by at least 10%, 20%, 50%, 60% or 70% when the non-dairy analog is combined with the aqueous composition, wherein the aqueous composition has an aqueous composition pH of between 3 to 10, before the non-dairy analog is combined with the aqueous composition or after the non-dairy analog is combined with the aqueous composition.

B36. The method of one or more of clauses B1 to B32, wherein the succinylated refined protein component increases the total solubility of the refined protein component by at least 10%, 20%, 50%, 60% or 70% when the non-dairy analog is combined with the aqueous composition, wherein the aqueous composition pH of the aqueous composition is less than 7, before the non-dairy analog is combined with the aqueous composition or after the non-dairy analog is combined with the aqueous composition.

B37. The method of one or more of clauses B1 to B32, wherein the succinylated refined protein component increases the total solubility of the refined protein component by at least 10%, 20%, 50%, 60% or 70% when the non-dairy analog is combined with the aqueous composition, wherein the aqueous composition pH of the aqueous composition is between 3 and 6, before the non-dairy analog is combined with the aqueous composition.

B38. The method of one or more of clauses B1 to B32, wherein the succinylated refined protein component increases the total solubility of the refined protein component by at least 10%, 20%, 50%, 60% or 70% when the non-dairy analog is combined with the aqueous composition, wherein the aqueous composition has a temperature of between 30° C. and 95° C. and the aqueous composition pH is between 3 to 10, before the non-dairy analog is combined with the aqueous composition or after the non-dairy analog is combined with the aqueous composition.

B39. The method of one or more of clauses B1 to B32, wherein the succinylated refined protein component increases the total solubility of the refined protein component by at least 10%, 20%, 50%, 60% or 70% when the non-dairy analog is combined with the aqueous composition, wherein the aqueous composition has a temperature of between 30° C. and 95° C. and the aqueous composition pH is less than 7, before the non-dairy analog is combined with the aqueous composition or after the non-dairy analog is combined with the aqueous composition.

B40. The method of one or more of clauses B1 to B32, wherein the succinylated refined protein component increases the total solubility of the refined protein component by at least 10%, 20%, 50%, 60% or 70% when the non-dairy analog is combined with the aqueous composition, wherein the aqueous composition has a temperature of between 30° C. and 95° C. and the aqueous composition pH is between 3 and 6, before the non-dairy analog is combined with the aqueous composition or after the non-dairy analog is combined with the aqueous composition.

B41. The method of one or more of clauses B1 to B40, wherein the refined protein component is sourced from a plant.

B42. The method of one or more of clauses B1 to B41, wherein the refined protein component is sourced from a legume.

B43. The method of one or more of clauses B1 to B42, wherein the refined protein component is sourced from a pea plant or a pea protein.

B44. The method of one or more of clauses B1 to B43, wherein the refined protein component is a refined pea protein component in which at least a portion of the refined pea protein component is a succinylated refined pea protein component.

B45. The method of one or more of clauses B1 to B44, wherein non-dairy analog has a pH between 4.0 and 8.3, 4.0 and 7.9, 6.5 and 7.9, 7 and 7.9 or 7.5 and 8.3.

B46. The method of one or more of clauses B1 to B44, wherein non-dairy analog has a pH at least 4.0, 6.5, 7.3, 7.4, 7.5, 7.6, 7.7, 7.8, 7.9, 8.0, 8.1, 8.2, or 8.3.

B47. The method of one or more of clauses B1 to B46, wherein the refined protein component is a color-neutral refined protein component.

B48. The method of one or more of clauses B1 to B46, wherein the refined protein component is not a color-neutral refined protein component.

B49. The method of one or more of clauses B1 to B46, wherein the non-dairy analog is capable of exhibiting less than 5%, 3%, 1% or 0.5% by volume precipitation when added to the aqueous composition after at least partial mixing of the non-dairy analog with the aqueous composition.

B50. The method of one or more of clauses B1 to B49, wherein the non-dairy analog is capable of exhibiting less than 1% or 0.5% by volume precipitation when added to the aqueous composition after at least partial mixing of the non-dairy analog with the aqueous composition.

B51. The method of one or more of clauses B1 to B50, wherein the non-dairy analog is capable of exhibiting less than 5%, 3%, 1% or 0.5% by volume precipitation when added to the aqueous composition after at least partial mixing of the non-dairy analog with the aqueous composition.

C1. A non-dairy analog comprising: (a) a refined protein component in which at least a portion of the refined protein component is a succinylated refined protein component; (b) at least one lipid from a non-animal natural source; (c) at least one emulsifier; (d) water; and (e) a pH of between 4.0 and 10, optionally, a pH of between 6.5 and 10.

C2. The non-dairy analog of clause 1, wherein: (a) at least 1% by weight of a refined protein component in which at least 30% by weight of the refined protein component is a succinylated refined protein component; (b) between 1% by weight and 10% by weight of at least one lipid from a non-animal natural source; and/or (c) between 0.01% by weight and 10% by weight of at least one emulsifier.

C3. The non-dairy analog of any one of clauses C1 or C2, wherein the refined protein component comprises is at least 2%, 3%, 5%, 8% or 10% by weight of the non-dairy analog; optionally, between 2% to 5%, 3% to 4%, 1% to 10%, 1% to 5%, 3% to 8% or 2% to 4% by weight of the non-dairy analog.

C4. The non-dairy analog of any one of clauses C1 to C3, wherein the succinylated refined protein component is at least 30%, 40%, 50%, 60%, 70%, 80%, 90% or 100% by weight of the total weight of the refined protein component; optionally, wherein the succinylated refined protein component is between 30% to 100%, 40% to 100%, 40% to 60%, 40% to 70% or 30% to 50% by weight of the total weight of the refined protein component.

C5. The non-dairy analog of any one of clauses C1 to C4, wherein the succinylated refined protein component is succinylated by succinic anhydride treatment.

C6. The non-dairy analog of any one of clauses C1 to C5, wherein the succinic anhydride treatment comprises at least 5 wt %, at least 10 wt %, at least 20 wt %, at least 30 wt %, at least 40 wt %, or at least 50 wt % succinic anhydride relative to refined protein; optionally, between about 5 wt % and 50 wt % succinic anhydride, or between about 10 wt % and 35 wt % succinic anhydride relative to refined protein.

C7. The non-dairy analog of any one of clauses C1 to C6, wherein the refined protein component is sourced from a plant; optionally, sourced from a legume.

C8. The non-dairy analog of any one of clauses C1 to C7, wherein the refined protein component is sourced from a pea plant or a pea protein.

C9. The non-dairy analog of any one of clauses C1 to C8, wherein the pH of the non-dairy analog is at least 4.0, 6.5, 7.3, 7.4, 7.5, 7.6, 7.7, 7.8, 7.9, 8.0, 8.1, 8.2, or 8.3; optionally, wherein the pH is between 4.0 and 8.3, 4.0 and 7.9, 6.5 and 7.9, 7 and 7.9, or 7.5 and 8.3. wherein the pH of the non-dairy analog.

C10. The non-dairy analog of any one of clauses C1 to C9, wherein after at least partial mixing with an aqueous solution, the non-dairy analog: (a) exhibits no visible feathering for at least 5 minutes, 10 minutes, or 15 minutes after mixing; (b) exhibits no visible precipitation for at least 5 minutes, 10 minutes, or 15 minutes after mixing; (c) exhibits insubstantial precipitation for at least 5 minutes, 10 minutes, or 15 minutes after mixing; (d) exhibits less than 5%, 3%, 1% or 0.5% by weight precipitation; optionally, wherein the by weight precipitation is exhibited for at least 5 minutes, 10 minutes, or 15 minutes after mixing; (e) exhibits less than 5%, 3%, 1% or 0.5% by volume precipitation; optionally, wherein the by volume precipitation is exhibited for at least 5 minutes, 10 minutes, or 15 minutes after mixing; and/or (f) is solubilized, or substantially solubilized, for at least 5 minutes, 10 minutes, or 15 minutes after mixing.

C11. The non-dairy analog of any one of clauses C1 to C10, wherein the aqueous composition has a temperature between 30° C. and 95° C.

C12. The non-dairy analog of any one of clauses C1 to C11, wherein the aqueous composition has a pH of less than 7, before the non-dairy analog is mixed with it; optionally wherein the aqueous composition has a pH less than 7 after the non-dairy analog is mixed with it.

C13. The non-dairy analog of any one of clauses C1 to C12, wherein the total solubility of the refined protein component of the non-dairy analog when combined with an aqueous composition is increased at least 10%, 20%, 50%, 60%, or 70% relative to the non-dairy analog without the succinylated refined protein component.

C14. The non-dairy analog of clause C13, wherein: (a) the aqueous composition pH is between 3 to 10, before the non-dairy analog is combined with the aqueous composition; (b) the aqueous composition pH is less than 7, before the non-dairy analog is combined with the aqueous composition; (c) wherein the aqueous composition pH is between 3 and 6, before the non-dairy analog is combined with the aqueous composition; (d) wherein the aqueous composition has a temperature of between 30 degrees Celsius and 95 degrees Celsius the aqueous composition pH is between 3 and 10, before the non-dairy analog is combined with the aqueous composition; (e) wherein the aqueous composition has a temperature of between 30 degrees Celsius and 95 degrees Celsius and the aqueous composition pH is less than 7, before the non-dairy analog is combined with the aqueous composition; or (f) wherein the aqueous composition has a temperature of between 30 degrees Celsius and 95 degrees Celsius and the aqueous composition pH of between 3 and 6, before the non-dairy analog is combined with the aqueous composition.

D1. A method for producing a non-dairy analog, the method comprising: (a) blending with water to generate a mixture (i) at least one lipid from a non-animal natural source, and (ii) at least one refined protein component from a non-animal natural source, wherein at least a portion of the refined protein component comprises a succinylated refined protein; and (b) emulsifying at least a portion of the mixture to provide a non-dairy analog.

D2. The method of clause D1, wherein the succinylated refined protein component is succinylated by succinic anhydride treatment.

D3. The method of clause D2, wherein the succinic anhydride treatment comprises at least 5 wt %, at least 10 wt %, at least 20 wt %, at least 30 wt %, at least 40 wt %, or at least 50 wt % succinic anhydride relative to refined protein; optionally, between about 5 wt % and 50 wt % succinic anhydride, or between about 10 wt % and 35 wt % succinic anhydride relative to refined protein.

D4. The method of any one of clauses D1 to D3, wherein the refined protein component is sourced from a plant; optionally, sourced from a legume.

D5. The method of any one of clauses D1 to D4, wherein the refined protein component is sourced from a pea plant or a pea protein.

D6. The method of any one of clauses D1 to D5, wherein: (a) at least 2% by weight of a refined protein component in which at least 30% by weight of the refined protein component is a succinylated refined protein component; (b) between 1% by weight and 10% by weight of at least one lipid from a non-animal natural source; and/or (c) between 0.01% by weight and 10% by weight of at least one emulsifier.

D7. The method of any one of clauses D1 to D6, wherein the refined protein component comprises is at least 1%, 2%, 3%, 5%, 8% or 10% by weight of the non-dairy analog; optionally, between 2% to 5%, 3% to 4%, 1% to 10%, 1% to 5%, 3% to 8% or 2% to 4% by weight of the non-dairy analog.

D8. The method of any one of clauses D1 to D7, wherein the succinylated refined protein component is at least 30%, 40%, 50%, 60%, 70%, 80%, 90% or 100% by weight of the total weight of the refined protein component; optionally, wherein the succinylated refined protein component is between 30% to 100%, 40% to 100%, 40% to 60%, 40% to 70% or 30% to 50% by weight of the total weight of the refined protein component.

E1. A beverage formulation comprising: (a) a refined protein component in which at least a portion of the refined protein component is a succinylated refined protein component; (b) water or carbonated water; and (c) a pH of between 6 and 9.

E2. The beverage formulation of clause E1, wherein the succinylated refined protein component is at least 30%, 40%, 50%, 60%, 70%, 80%, 90% or 100% by weight of the total weight of the refined protein component; optionally, wherein the succinylated refined protein component is between 30% to 100%, 40% to 100%, 40% to 60%, 40% to 70% or 30% to 50% by weight of the total weight of the refined protein component.

E3. The beverage formulation of any one of clauses E1 to E2, wherein the refined protein component comprises is at least 1%, 2%, 3%, 5%, 8% or 10% by weight of the beverage formulation; optionally, between 1% to 10%, 1% to 5%, 2% to 5%, 3% to 4%, 3% to 8%, or 2% to 4% by weight of the beverage formulation.

E4. The beverage formulation of any one of clauses E1 to E3, wherein the beverage: (a) exhibits less than 5%, 3%, 1% or 0.5% by weight precipitation of the refined protein component; and/or (b) exhibits less than 5%, 3%, 1% or 0.5% by volume precipitation of the refined protein component.

E5. The beverage formulation of any one of clauses E1 to E4, wherein the refined protein component is sourced from a plant; optionally, sourced from a legume.

E6. The beverage formulation of any one of clauses E1 to E5, wherein the refined protein component is sourced from a pea plant or a pea protein.

E7. The beverage formulation of any one of clauses E1 to E6, wherein the beverage formulation further comprises: (a) sugar and/or a carbohydrate; (b) at least one vitamin or mineral; (c) at least one lipid from a non-animal natural source; and/or (d) at least one emulsifier, and/or a hydrocolloid or gum.

E8. The beverage formulation of any one of clause E1 to E7, wherein the beverage formulation is selected from: a protein drink, a vitamin drink, a fruit juice drink, or an iced tea drink.

While the foregoing disclosure of the present invention has been described in some detail by way of example and illustration for purposes of clarity and understanding, this disclosure including the examples, descriptions, and embodiments described herein are for illustrative purposes, are intended to be exemplary, and should not be construed as limiting the present disclosure. It will be clear to one skilled in the art that various modifications or changes to the examples, descriptions, and embodiments described herein can be made and are to be included within the spirit and purview of this disclosure and the appended claims. Further, one of skill in the art will recognize a number of equivalent methods and procedure to those described herein. All such equivalents are to be understood to be within the scope of the present disclosure and are covered by the appended claims.

Additional embodiments of the invention are set forth in the following claims.

The disclosures of all publications, patent applications, patents, or other documents mentioned herein are expressly incorporated by reference in their entirety for all purposes to the same extent as if each such individual publication, patent, patent application or other document were individually specifically indicated to be incorporated by reference herein in its entirety for all purposes and were set forth in its entirety herein. In case of conflict, the present specification, including specified terms, will control.

What is claimed:

1. A non-dairy analog comprising:
(a) a refined protein component in which at least a portion of the refined protein component is a succinylated refined protein component;
(b) at least one lipid from a non-animal natural source;
(c) at least one emulsifier;
(d) water; and
(e) a pH of between 4.0 and 10.

2. The non-dairy analog of claim 1, wherein:
(a) at least 2% by weight of a refined protein component in which at least 30% by weight of the refined protein component is a succinylated refined protein component;
(b) between 1% by weight and 10% by weight of at least one lipid from a non-animal natural source; and/or
(c) between 0.01% by weight and 10% by weight of at least one emulsifier.

3. The non-dairy analog of claim 1, wherein:
(a) the refined protein component comprises at least 1%, 2%, 3%, 5%, 8% or 10% by weight of the non-dairy analog;
(b) the succinylated refined protein component is at least 30%, 40%, 50%, 60%, 70%, 80%, 90% or 100% by weight of the total weight of the refined protein component;
(c) the succinylated refined protein component is succinylated by succinic anhydride treatment; optionally, wherein the succinic anhydride treatment comprises at least 5 wt %, at least 10 wt %, at least 20 wt %, at least 30 wt %, at least 40 wt %, or at least 50 wt % succinic anhydride relative to refined protein; and/or
(d) the pH of the non-dairy analog is at least 4.0, 6.5, 7.3, 7.4, 7.5, 7.6, 7.7, 7.8, 7.9, 8.0, 8.1, 8.2, or 8.3.

4. The non-dairy analog of claim 1, wherein the refined protein component is sourced from a legume; optionally, wherein the refined protein component is sourced from a pea plant or a pea protein.

5. The non-dairy analog of claim 1, wherein after at least partial mixing with an aqueous solution, the non-dairy analog:
(a) exhibits no visible feathering for at least 5 minutes, 10 minutes, or 15 minutes after mixing;
(b) exhibits no visible precipitation for at least 5 minutes, 10 minutes, or 15 minutes after mixing;
(c) exhibits insubstantial precipitation for at least 5 minutes, 10 minutes, or 15 minutes after mixing;
(d) exhibits less than 5%, 3%, 1% or 0.5% by weight precipitation; optionally, wherein the by weight precipitation is exhibited for at least 5 minutes, 10 minutes, or 15 minutes after mixing;
(e) exhibits less than 5%, 3%, 1% or 0.5% by volume precipitation; optionally, wherein the by volume precipitation is exhibited for at least 5 minutes, 10 minutes, or 15 minutes after mixing; and/or
(f) is solubilized, or substantially solubilized, for at least 5 minutes, 10 minutes, or 15 minutes after mixing.

6. The non-dairy analog of claim 5, wherein the aqueous solution has a temperature between 30° C. and 95° C.

7. The non-dairy analog of claim 5, wherein the aqueous solution has a pH of less than 7, before the non-dairy analog is mixed with it; optionally wherein the aqueous solution has a pH less than 7 after the non-dairy analog is mixed with it.

8. The non-dairy analog of claim 5, wherein the total solubility of the refined protein component of the non-dairy analog when combined with an aqueous solution is increased at least 10%, 20%, 50%, 60%, or 70% relative to the non-dairy analog without the succinylated refined protein component.

9. The non-dairy analog of claim 5, wherein:
(a) the aqueous composition pH is between 3 to 10, before the non-dairy analog is combined with the aqueous solution;
(b) the aqueous composition pH is less than 7, before the non-dairy analog is combined with the aqueous solution;
(c) wherein the aqueous composition pH is between 3 and 6, before the non-dairy analog is combined with the aqueous solution;
(d) wherein the aqueous composition has a temperature of between 30° C. and 95° C. and a pH is between 3 and 10, before the non-dairy analog is combined with the aqueous solution;
(e) wherein the aqueous composition has a temperature of between 30° C. and 95° C. and a pH of less than 7, before the non-dairy analog is combined with the aqueous solution; or
(f) wherein the aqueous composition has a temperature of between 30° C. and 95° C. and a pH of between 3 and 6, before the non-dairy analog is combined with the aqueous solution.

10. A method for producing a non-dairy analog, the method comprising:
(a) blending with water to generate a mixture:
(i) at least one lipid from a non-animal natural source, and
(ii) at least one refined protein component from a non-animal natural source, wherein at least a portion of the refined protein component comprises a succinylated refined protein; and
(b) emulsifying at least a portion of the mixture to provide a non-dairy analog.

11. The method of claim 10, wherein the succinylated refined protein component is succinylated by succinic anhydride treatment; optionally, wherein the succinic anhydride treatment comprises at least 5 wt %, at least 10 wt %, at least 20 wt %, at least 30 wt %, at least 40 wt %, or at least 50 wt % succinic anhydride relative to refined protein; optionally, between about 5 wt % and 50 wt % succinic anhydride, or between about 10 wt % and 35 wt % succinic anhydride relative to refined protein.

12. The method of claim 10, wherein the refined protein component is sourced from a legume; optionally, wherein the refined protein component is sourced from a pea plant or a pea protein.

13. The method of claim 10, wherein,
(a) at least 1% by weight of a refined protein component in which at least 30% by weight of the refined protein component is a succinylated refined protein component;
(b) between 1% by weight and 10% by weight of at least one lipid from a non-animal natural source; and/or
(c) between 0.01% by weight and 10% by weight of at least one emulsifier.

14. The method of claim 10, wherein:
(a) the refined protein component comprises is at least 1%, 3%, 5%, 8% or 10% by weight of the non-dairy analog; and/or
(b) the succinylated refined protein component is at least 30%, 40%, 50%, 60%, 70%, 80%, 90% or 100% by weight of the total weight of the refined protein component.

15. A beverage formulation comprising:
(a) a refined protein component in which at least a portion of the refined protein component is a succinylated refined protein component;
(b) water or carbonated water; and
(c) a pH of between 6 and 9.

16. The beverage formulation of claim 15, wherein:
(a) the succinylated refined protein component is at least 30%, 40%, 50%, 60%, 70%, 80%, 90% or 100% by weight of the total weight of the refined protein component; and/or
(b) the refined protein component comprises is at least 1%, 2%, 3%, 5%, 8% or 10% by weight of the beverage formulation.

17. The beverage formulation of claim 15, wherein the beverage:
(a) exhibits less than 5%, 3%, 1% or 0.5% by weight precipitation of the refined protein component; and/or
(b) exhibits less than 5%, 3%, 1% or 0.5% by volume precipitation of the refined protein component.

18. The beverage formulation of claim 15, wherein the refined protein component is sourced from a legume; optionally, wherein the refined protein component is sourced from a pea plant or a pea protein.

19. The beverage formulation of claim 15, wherein the beverage formulation further comprises:
(a) sugar and/or a carbohydrate;
(b) at least one vitamin or mineral;
(c) at least one lipid from a non-animal natural source; and/or
(d) at least one emulsifier, and/or a hydrocolloid or gum.

20. The beverage formulation of claim 15, wherein the beverage formulation is selected from: a protein drink, a vitamin drink, a fruit juice drink, or an iced tea drink.
